(19) United States
(12) Patent Application Publication
(10) Pub. No.: US 2025/0252736 A1
(43) Pub. Date: Aug. 7, 2025

(54) VIDEO PROCESSING SYSTEM, VIDEO PROCESSING APPARATUS, AND VIDEO PROCESSING METHOD

(71) Applicant: NEC Corporation, Minato-ku, Tokyo (JP)

(72) Inventors: Koichi NIHEI, Tokyo (JP); Takanori IWAI, Tokyo (JP); Florian BEYE, Tokyo (JP); Katsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 18/855,702

(22) PCT Filed: Jul. 14, 2022
(86) PCT No.: PCT/JP2022/027713

§ 371 Date: Oct. 10, 2024

(51) Int. Cl. G06V 20/40; G06V 10/94; G06V 10/96

(52) U.S. Cl. CPC G06V 20/44; G06V 10/95; G06V 10/96

(57) ABSTRACT

A video processing system (10) includes a recognition model (M1) that analyzes a video corresponding to a first video recognition environment; a recognition model (M2) that analyzes a video corresponding to a second video recognition environment; and a switching unit (11) that switches a recognition model for analyzing video input data to be input, from the recognition model (M1) to the recognition model (M2) according to a change from the first video recognition environment to the second video recognition environment in the video input data, in which the switching unit (11) inputs video input data including data preceding a switching timing by a predetermined period to the recognition model 10 (M2) according to the change from the first video recognition environment to the second video recognition environment in the video input data.

### TECHNICAL FIELD

The present disclosure relates to a video processing system, a video processing apparatus, and a video processing method.

### BACKGROUND ART

A technique of recognizing an event in a video on the basis of the video acquired via a network has been developed. For example, a recognition model using machine learning is used for video recognition of analyzing a video and recognizing an event in the video. The recognition model is also referred to as an analysis model or a recognition engine.

Patent Literatures 1 and 2 are known as related techniques. Patent Literature 1 describes a technique in which a first recognition engine and a second recognition engine recognize a context on the basis of an input video. In addition, Patent Literature 1 also describes that a plurality of recognition engines of different types may be automatically selected at predetermined time intervals.

In addition, Patent Literature 2 describes a technique of selecting a recognition engine for input data using a learning model trained by associating the input data with an identifier of the recognition engine.

### CITATION LIST

### Patent Literature

Patent Literature 1: Japanese Unexamined Patent Application Publication No. 2019-096252
Patent Literature 2: Japanese Unexamined Patent Application Publication No. 2019-139479

### SUMMARY OF INVENTION

### Technical Problem

As described above, in related techniques such as Patent Literatures 1 and 2, a recognition model is selected, and a video is analyzed by the selected recognition model. However, in the related technique, there is a possibility that an event in the video cannot be suitably recognized depending on an environment of the acquired video.

In view of such a problem, an object of the present disclosure is to provide a video processing system, a video processing apparatus, and a video processing method capable of suitably recognizing an event in a video.

### Solution to Problem

A video processing system according to an aspect of the present disclosure includes a first video analysis model that analyzes a video corresponding to a first video recognition environment; a second video analysis model that analyzes a video corresponding to a second video recognition environment; and switching means for switching a video analysis model for analyzing video input data to be input, from the first video analysis model to the second video analysis model according to a change from the first video recognition environment to the second video recognition environment in the video input data, in which the switching means inputs video input data including data preceding a switching timing by a predetermined period to the second video analysis model according to the change from the first video recognition environment to the second video recognition environment in the video input data.

A video processing apparatus according to another aspect of the present disclosure includes a first video analysis model that analyzes a video corresponding to a first video recognition environment; a second video analysis model that analyzes a video corresponding to a second video recognition environment; and switching means for switching a video analysis model for analyzing video input data to be input, from the first video analysis model to the second video analysis model according to a change from the first video recognition environment to the second video recognition environment in the video input data, in which the switching means inputs video input data including data preceding a switching timing by a predetermined period to the second video analysis model according to the change from the first video recognition environment to the second video recognition environment in the video input data.

A video processing method according to still another aspect of the present disclosure includes switching a video analysis model for analyzing video input data to be input, from a first video analysis model that analyzes a video corresponding to a first video recognition environment, to a second video analysis model that analyzes a video corresponding to a second video recognition environment, according to a change from the first video recognition environment to the second video recognition environment in the video input data; and inputting video input data including data preceding a switching timing by a predetermined period to the second video analysis model according to the change from the first video recognition environment to the second video recognition environment in the video input data.

### Advantageous Effects of Invention

According to the present disclosure, it is possible to provide a video processing system, a video processing apparatus, and a video processing method capable of suitably recognizing an event in a video.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to an example embodiment.

FIG. 3 is a configuration diagram illustrating an outline of a video processing apparatus according to an example embodiment.

FIG. 4 is a flowchart illustrating an outline of a video processing method according to an example embodiment.

FIG. 5 is a diagram for describing a related video processing method.

FIG. 6 is a diagram for describing a video processing method according to an example embodiment.

FIG. 7 is a configuration diagram illustrating a basic configuration of a remote monitoring system according to an example embodiment.

FIG. 8 is a configuration diagram illustrating a configuration example of a remote monitoring system according to a first example embodiment.

FIG. 9 is a diagram illustrating a specific example of a bit rate-recognition model table according to the first example embodiment.

FIG. 10 is a diagram illustrating a specific example of a recognition model-frame number table according to the first example embodiment.

FIG. 11 is a flowchart illustrating an operation example of the remote monitoring system according to the first example embodiment.

FIG. 12 is a configuration diagram illustrating a configuration example of a remote monitoring system according to a second example embodiment.

FIG. 13 is a configuration diagram illustrating a configuration example of a remote monitoring system according to a third example embodiment.

FIG. 14 is a diagram illustrating a specific example of a frame rate-recognition model table according to the third example embodiment.

FIG. 15 is a configuration diagram illustrating a configuration example of a remote monitoring system according to a fourth example embodiment.

FIG. 16 is a diagram for describing an operation example of the remote monitoring system according to the fourth example embodiment.

FIG. 17 is a diagram illustrating a specific example of a packet loss-recognition model table according to a fifth example embodiment.

FIG. 18 is a configuration diagram illustrating a configuration example of a remote monitoring system according to a sixth example embodiment.

FIG. 19 is a diagram illustrating a specific example of a scene-recognition model table according to the sixth example embodiment.

FIG. 20 is a configuration diagram illustrating a configuration example of a remote monitoring system according to a seventh example embodiment.

FIG. 21 is a diagram illustrating a specific example of an object size-recognition model table according to the seventh example embodiment.

FIG. 22 is a configuration diagram illustrating a configuration example of a remote monitoring system according to an eighth example embodiment.

FIG. 23 is a diagram illustrating a specific example of a motion speed-recognition model table according to the eighth example embodiment.

FIG. 24 is a configuration diagram illustrating a configuration example of a remote monitoring system according to a ninth example embodiment.

FIG. 25 is a diagram illustrating a specific example of an imaging state-recognition model table according to the ninth example embodiment.

FIG. 26 is a configuration diagram illustrating a configuration example of a remote monitoring system according to a tenth example embodiment.

FIG. 27 is a diagram illustrating a specific example of a calculation amount-recognition model table according to the tenth example embodiment.

FIG. 28 is a configuration diagram illustrating a configuration example of a remote monitoring system according to an eleventh example embodiment.

FIG. 29 is a diagram illustrating a specific example of a transmission band-recognition model table according to the eleventh example embodiment.

FIG. 30 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

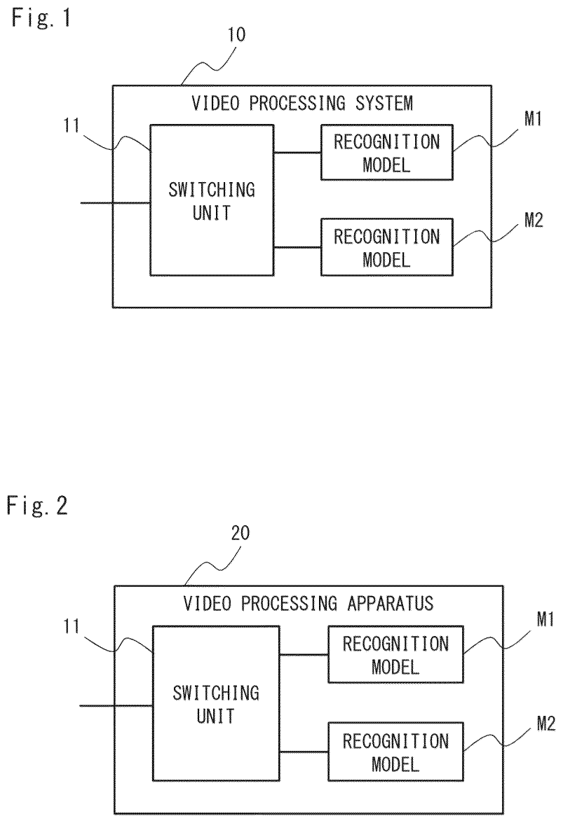

First, an outline of an example embodiment will be described. FIG. 1 illustrates a schematic configuration of a video processing system 10 according to the example embodiment. For example, the video processing system 10 is applicable to a remote monitoring system that collects videos via a network and analyzes the videos.

As illustrated in FIG. 1, the video processing system 10 includes recognition models M1 and M2 and a switching unit 11. The recognition model M1 is a first video analysis model that analyzes a video corresponding to a first video recognition environment. The recognition model M2 is a second video analysis model that analyzes a video corresponding to a second video recognition environment. The recognition models M1 and M2 recognize, for example, a face of a person, a vehicle, an instrument, and the like according to the input video. In addition, for example, the recognition models M1 and M2 may recognize a behavior of a person, a traveling situation of a vehicle, a state of an object, and the like. Note that a recognition target to be recognized by the recognition models M1 and M2 is not limited to these examples. The video processing system 10 may include three or more recognition models without being limited to the two recognition models.

For example, the recognition model M1 may be generated by learning video learning data corresponding to the first video recognition environment, and the recognition model M2 may be generated by learning video learning data corresponding to the second video recognition environment. In addition, the created recognition model may be acquired and evaluated. For example, recognition accuracy may be evaluated using the video corresponding to the first video recognition environment for a plurality of created recognition models, and the recognition model with the highest accuracy may be determined as the recognition model M1 used for the first video recognition environment. Similarly, recognition accuracy may be evaluated using the video corresponding to the second video recognition environment for a plurality of created recognition models and the recognition model with the highest accuracy may be determined as the recognition model M2 used for the second video recognition environment.

The video recognition environment is an environment of a video analyzed and recognized by the recognition model, and may indicate quality of the video or indicate an environment including an object shown in the video. Note that the term “analyzing and recognizing” means that either the analysis or the recognition is performed. In addition, the video recognition environment may include, for example, video parameters such as a bit rate and a frame rate indicating the quality of video, a communication quality of a video received via a network, a scene in which the video is captured, a size of an object included in the video, a motion speed of the object included in the video, an imaging state in which the video is captured, and the like. The scene is, for example, the progress of a process at a construction site, work contents of a worker, a work place, or the like.

The switching unit 11 switches recognition models for analyzing the video input data, that is, the video analysis models according to a change from the first video recognition environment to the second video recognition environment in the input video input data. The video input data is video data on which the recognition model M1 or M2 performs analysis and recognition processing, and includes recognition targets such as a face of a person, a vehicle, and an instrument. In a case where the video input data is input to the recognition models M1 and M2, the recognition models M1 and M2 may perform analysis and recognition processing. According to the change from the first video recognition environment to the second video recognition environment in the video input data, the switching unit 11 inputs the video input data including data preceding a switching timing by a predetermined period, to the recognition model M2 as a switching destination. That is, the switching unit 11 inputs data from a predetermined period before the switching timing to the switching timing to the recognition model M2, and further inputs data after the switching timing to the recognition model M2. Note that the same applies to a case where the recognition model M2 is switched to the recognition model M1.

The switching unit 11 may input the video input data including data with a number of frames used by the recognition model M2 as the switching destination to perform the video recognition, to the recognition model M2 as the switching destination, as the video input data including the data preceding the switching timing by the predetermined period. In addition, the switching unit 11 may input the video input data including the data preceding the switching timing by the predetermined period, to both the recognition model M1 as a switching source and the recognition model M2 as the switching destination. That is, the switching unit 11 may input the data from the predetermined period before the switching timing to the switching timing, to the recognition models M1 and M2.

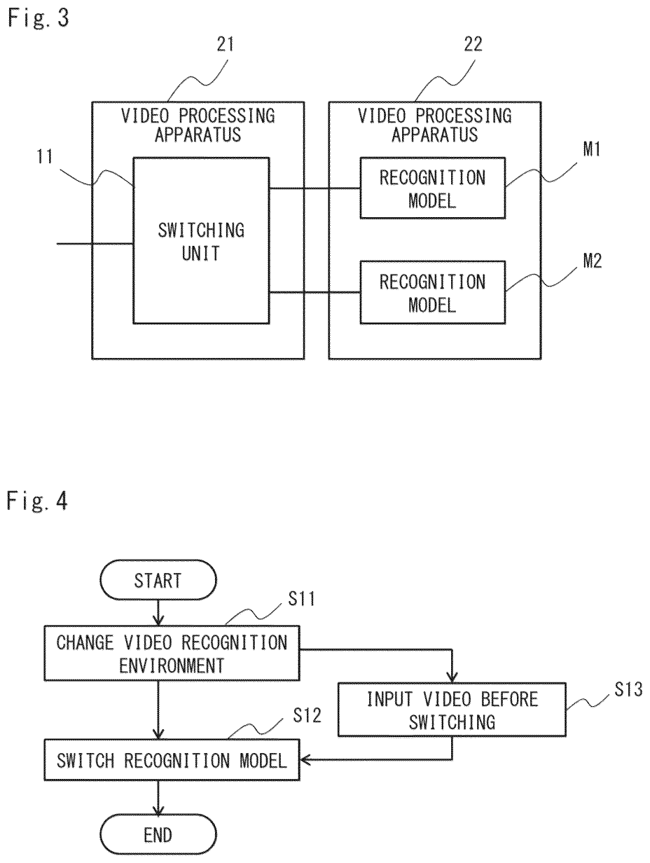

Note that the video processing system 10 may be configured by one apparatus or a plurality of apparatuses. FIG. 2 illustrates a configuration of a video processing apparatus 20 according to the example embodiment. As illustrated in FIG. 2, the video processing apparatus 20 may include the recognition models M1 and M2 and the switching unit 11 illustrated in FIG. 1. In addition, a part or all of the video processing system 10 may be arranged on an edge or a cloud. For example, the recognition models M1 and M2 and the switching unit 11 may be arranged in a server of a cloud. Furthermore, each function may be distributed in the cloud. FIG. 3 illustrates a configuration in which functions of the video processing system 10 are arranged in a plurality of video processing apparatuses. In the example of FIG. 3, a video processing apparatus 21 includes the switching unit 11, and a video processing apparatus 22 includes the recognition models M1 and M2. Note that the configuration of FIG. 3 is an example, and the present invention is not limited to this configuration.

In addition, the recognition models M1 and M2 may be arranged at the same point or may be arranged at different points. For example, the recognition model M1 may be arranged on one of the edge and the cloud, and the recognition model M2 may be arranged on the other of the edge and the cloud.

FIG. 4 illustrates a video processing method according to the example embodiment. For example, the video processing method according to the example embodiment is executed by the video processing system 10 of FIG. 1 or by the video processing apparatuses 20 to 22 of FIG. 2 or 3. As illustrated in FIG. 4, according to a change from the first video recognition environment to the second video recognition environment in the input video input data (S11), the recognition models that analyze the video input data, that is, the video analysis models are switched from the recognition model M1 that analyzes the video corresponding to the first video recognition environment to the recognition model M2 that analyzes the video corresponding to the second video recognition environment (S12). In addition, according to a change from the first video recognition environment to the second video recognition environment in the video input data (S11), the video input data including data preceding the switching timing by the predetermined period is input to the recognition model M2 (S13).

Here, problems in the related technique before application of the example embodiment will be described. Specifically, a video processing method will be considered in which a video is transmitted from a terminal to a server and the server switches the recognition models by using the related techniques as in Patent Literatures 1 and 2.

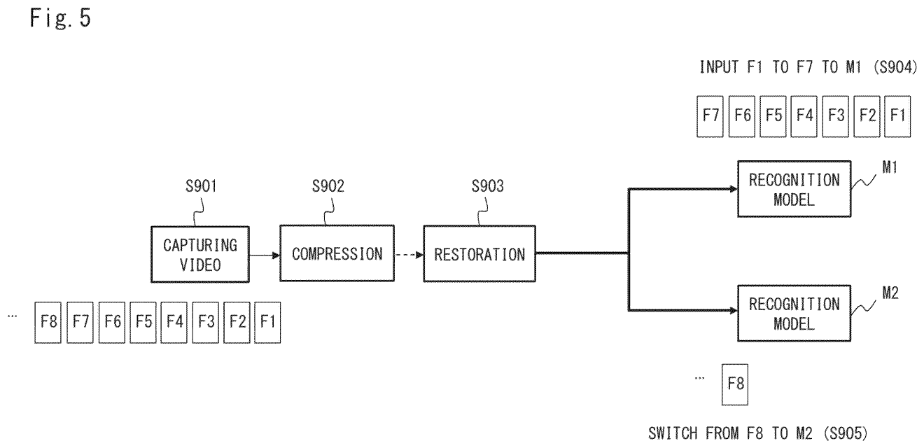

FIG. 5 illustrates an operation in a case where one of the recognition models M1 and M2 in FIG. 1 is selected and switched in the related video processing method. For example, the recognition models M1 and M2 are models that learn and analyze videos of different bit rates or compression rates. In this example, the video to be captured and analyzed includes frames F1 to F8 . . . arranged in time series, and the recognition model M1 is switched to the recognition model M2 at the timing of the frame F8. Note that, here, as an example, the compressed and restored video is input to the recognition model, but the present invention is not limited to this configuration as long as the video that can be analyzed and recognized can be input to each recognition model. For example, the video processing system that executes the video processing method of FIG. 5 may further include an imaging unit that captures a video, a compression unit that compresses the video, and a restoration unit that restores the compressed video, in addition to the configuration of FIG. 1. For example, the video processing system that executes the video processing method of FIG. 5 may not include the compression unit and the restoration unit.

As illustrated in FIG. 5, in the related video processing method, the imaging unit captures a video (S901), and the compression unit compresses the captured video (S902). Next, the compressed video is transmitted from the compression unit to the restoration unit, and the restoration unit restores the received compressed video to the original video (S903). Next, the switching unit selects the recognition model M1, and inputs the frames F1 to F7 to the recognition model M1 before switching (S904). The recognition model M1 before switching performs video recognition using the input frames F1 to F7.

Next, at the switching timing, the switching unit switches the recognition model from M1 to M2, and inputs frames after the frame F8 to the recognition model M2 after the switching (S905). The recognition model M2 after the switching performs the video recognition using the input frames after the frame F8.

As a result of examining the recognition accuracy in a case where the recognition model is switched as illustrated in FIG. 5 in the related video processing method, the inventors have found the following problems. Specifically, in the video processing method of performing analysis by switching a plurality of models, in a case where a recognition model uses analysis information of the past frame, there is a case where sufficient analysis accuracy cannot be obtained even in a case where the recognition model is switched. That is, in the video recognition model that recognizes an event using the video, in a case where the recognition model to which the video is input is changed as in the related video processing method, there is a possibility that the recognition accuracy at the time of changing the recognition model as a change destination is lowered.

The recognition model is a video recognition engine using machine learning, and is, for example, a learning model that learns a motion or the like of a person as a recognition target on the basis of time-series video data at the time of learning. The recognition model extracts a feature of a temporal change of each frame of the video data, and learns a motion or the like of a person. Therefore, it is assumed that the time-series video data is input to the recognition model also at the time of recognition, and it is necessary to input the video with a sufficient number of frames to extract the features of the temporal change in each frame of the video data, to the recognition model also at the time of recognition.

However, in the example of FIG. 5, when the recognition model M1 is switched to the recognition model M2, since input to the recognition model M2 after the switching begins with the frame F8 after the switching, only video data from the frame F8 onwards is input to the recognition model M2. Then, since the past data preceding the frame F8 is not input to the recognition model M2, the recognition model M2 cannot analyze time-series data immediately after the switching, that is, at the moment of the switching. Therefore, there is a possibility that, immediately after the switching, the recognition accuracy, that is, the analysis accuracy of the recognition model M2 as the switching destination is decreased or the recognition result is not obtained. The recognition model M2 cannot correctly analyze the past data, there is a possibility that the recognition target in the video is erroneously recognized, and there may be a case where the recognition result cannot be output.

Specific examples in which such a problem occurs include an example in which it is not possible to recognize whether a person is about to get on a vehicle or a person is about to get off a vehicle even when only a video at a moment when a person opens a door of a vehicle is input to a recognition model, an example in which it is not possible to recognize whether a person is walking forward or moving backward even when only a video at a moment when a person is walking is input to a recognition model, and an example in which it is not possible to recognize whether a person or a machine is about to lift an object or drop an object even when only a video at a moment when a person or a machine holds an object is input to a recognition model.

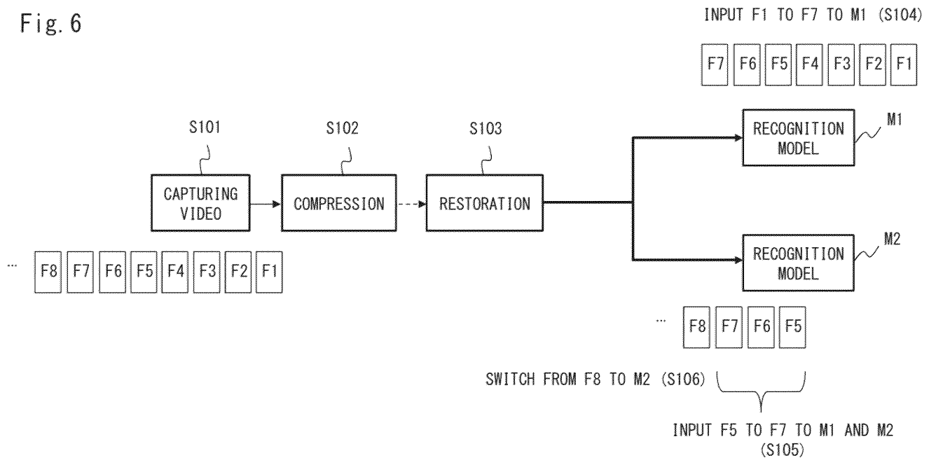

Therefore, in the example embodiment, as illustrated in FIGS. 1 to 4, when the recognition model is switched, the data preceding the switching is input to the recognition model as the switching destination. FIG. 6 illustrates an operation in a case where the recognition model is switched at the same timing as in FIG. 5 in the video processing method according to the example embodiment. Also in this example, as in FIG. 5, the recognition models M1 and M2 are models that learn and analyze videos of different bit rates or compression rates. As an example, the compressed and restored video is input to the recognition model, but the present invention is not limited to this configuration as long as the video that can be analyzed and recognized can be input to each recognition model. For example, the video processing system that executes the video processing method of FIG. 6 may further include an imaging unit that captures a video, a compression unit that compresses the video, and a restoration unit that restores the compressed video, in addition to the configuration of FIG. 1. For example, the video processing system that executes the video processing method of FIG. 6 may not include the compression unit and the restoration unit.

As illustrated in FIG. 6, in the video processing method according to the example embodiment, as in FIG. 5, the imaging unit captures a video (S101), the compression unit compresses the captured video (S102), and a decoding unit restores the compressed video to the original video (S103). Next, the switching unit selects the recognition model M1, and inputs the frames F1 to F7 to the recognition model M1 before switching (S104). The recognition model M1 before switching performs video recognition using the input frames F1 to F7.

Next, in the example embodiment, the switching unit inputs the frames F5 to F7 before the switching timing, to the recognition model M1 before the switching and the recognition model M2 after the switching (S105). Next, at the switching timing, the switching unit switches the recognition model from M1 to M2, and inputs frames after the frame F8 to the recognition model M2 after the switching (S106). Consequently, the recognition model M2 after the switching performs the video recognition using the frames after the frame F5 input before the switching timing.

As described above, in the example embodiment, the frame slightly before the model switching is input to both the recognition models before and after the switching. Consequently, the recognition model after the switching can perform the video recognition using the past data immediately after the switching, so that the decrease in recognition accuracy or the interruption of the analysis can be prevented. In addition, it is sufficient to input a sufficient number of frames to extract the features of the temporal change in each frame of the video data, to the recognition model as the switching destination. Therefore, since the data to be input to both the recognition models may be several frames, it is possible to suppress a decrease in recognition accuracy while maintaining the processing amounts processed by the two recognition models almost equally as compared with the related technique. That is, in a case where data is continuously input to both the recognition models, the processing amount is increased, but it is possible to suppress an increase in the processing amount by inputting only a predetermined number of frames before the switching timing to both the recognition models.

### Basic Configuration of Remote Monitoring System

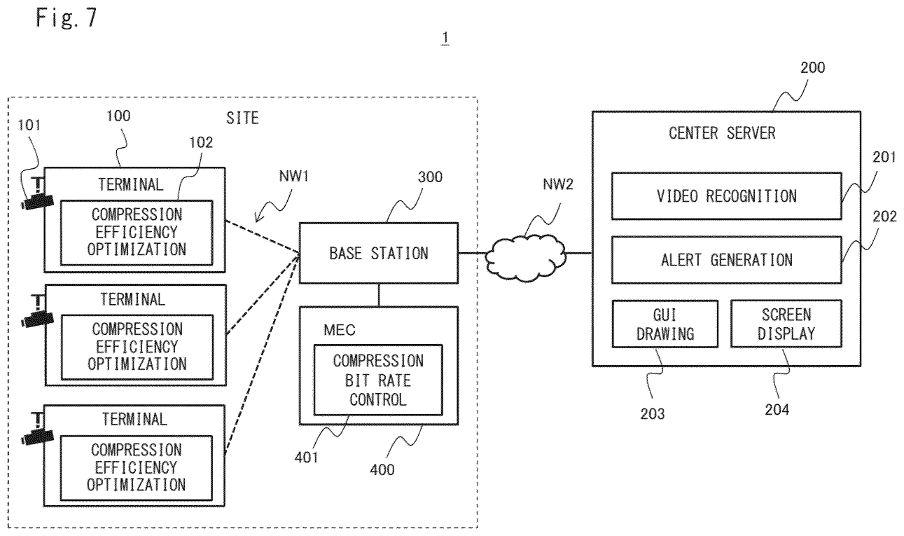

Next, a remote monitoring system which is an example of a system to which the example embodiment is applied will be described. FIG. 7 illustrates a basic configuration of a remote monitoring system 1. The remote monitoring system 1 is a system that monitors a captured area using a video captured by a camera. Hereinafter, the present example embodiment will be described as a system that remotely monitors work of a worker at a site. For example, the site may be an area where people and machines operate, such as a work site such as a construction site, a square where people gather, or a school. In the present example embodiment, hereinafter, the work will be described as construction work, civil engineering work, or the like, but the work is not limited thereto. Note that, since the video includes a plurality of time-series images (also referred to as frames), the video and the image can be paraphrased with each other. That is, the remote monitoring system can be said to be a video processing system that processes a video and an image processing system that processes an image.

As illustrated in FIG. 7, the remote monitoring system 1 includes a plurality of terminals 100, a center server 200, a base station 300, and MEC 400. The terminal 100, the base station 300, and the MEC 400 are disposed on the site side, and the center server 200 is disposed on the center side. For example, the center server 200 is disposed in a data center or the like disposed at a position away from the site. The site side is also referred to as an edge side of the system, and the center side is also referred to as a cloud side.

The terminal 100 and the base station 300 are communicably connected by a network NW1. The network NW1 is, for example, a wireless network such as 4G, local 5G/5G, long term evolution (LTE), or wireless LAN. Note that the network NW1 is not limited to a wireless network, and may be a wired network. The base station 300 and the center server 200 are communicably connected by a network NW2. The network NW2 includes, for example, a core network such as a 5th Generation Core network (5GC) or an Evolved Packet Core (EPC), the Internet, and the like. Note that the network NW2 is not limited to a wired network, and may be a wireless network. It can also be said that the terminal 100 and the center server 200 are communicably connected via the base station 300. The base station 300 and the MEC 400 are communicably connected by an arbitrary communication method, but the base station 300 and the MEC 400 may be one apparatus.

The terminal 100 is a terminal apparatus connected to the network NW1, and is also a video acquisition apparatus that acquires a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 that optimizes compression efficiency. The compression efficiency optimization function 102 includes a region of interest (ROI) control to control image quality in the RoI. The compression efficiency optimization function 102 reduces the bit rate by reducing the image quality of the region around the ROI including the person or the object while maintaining the image quality of the ROI.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, but may be another relay apparatus.

The multi-access edge computing (MEC) 400 is an edge processing apparatus disposed on the edge side of the system. The MEC 400 is an edge server that controls the terminal 100, and has a compression bit rate control function 401 that controls a bit rate of the terminal. The compression bit rate control function 401 controls a bit rate of the terminal 100 by adaptive video distribution control or quality of experience (QoE) control. The adaptive video distribution control controls a bit rate or the like of a video to be distributed according to a situation of a network. For example, the compression bit rate control function 401 predicts the recognition accuracy to be obtained while suppressing the bit rate according to a communication environment of the networks NW1 and NW2, and allocates the bit rate to the camera 101 of each terminal 100 so as to improve the recognition accuracy.

The center server 200 is a server installed on the center side of the system. The center server 200 may be one or a plurality of physical servers, a cloud server built on a cloud, or other virtualization servers. The center server 200 is a monitoring apparatus that monitors work at a site by analyzing a camera video of the site. The center server 200 is also a video analysis apparatus that analyzes a video transmitted from the terminal 100.

The center server 200 has a video recognition function 201, an alert generation function 202, a GUI drawing function 203, and a screen display function 204. The video recognition function 201 inputs the video transmitted from the terminal 100 to a video recognition artificial intelligence (AI) engine, thereby recognizing the work performed by the worker, that is, the type of behavior of the person. The video recognition function 201 may include a plurality of recognition models that analyze videos corresponding to different video recognition environments, that is, video analysis models. Furthermore, the center server 200 may include a switching unit that switches the recognition models according to a change in the video recognition environment. The alert generation function 202 generates an alert according to the recognized work. The GUI drawing function 203 displays a graphical user interface (GUI) on a screen of the display device. The screen display function 204 displays a video, a recognition result, an alert, and the like of the terminal 100 on the GUI. Note that any of the functions may be omitted or any of the functions may be included as necessary. For example, the center server 200 may not include the alert generation function 202, the GUI drawing function 203, and the screen display function 204.

### First Example Embodiment

Next, a first example embodiment will be described. In the present example embodiment, an example of switching the recognition model according to a change in a bit rate of a video, as the change in the video recognition environment, will be described.

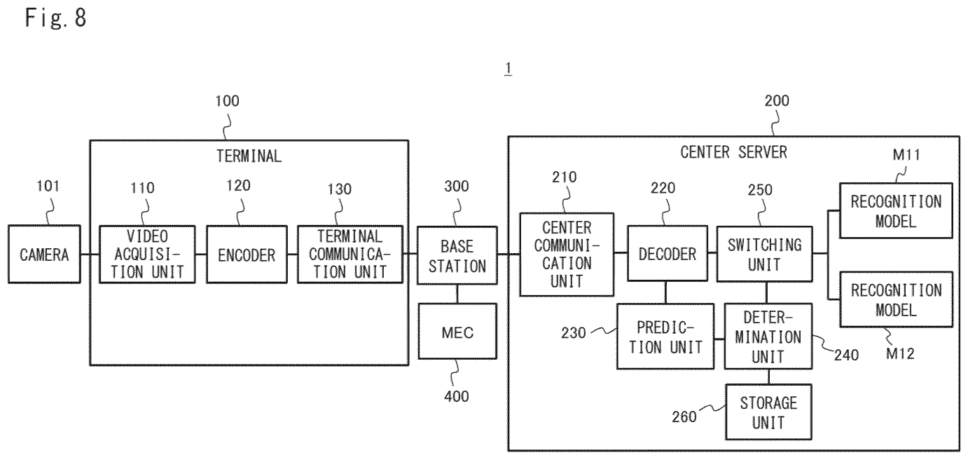

First, a configuration of a remote monitoring system according to the present example embodiment will be described. A basic configuration of the remote monitoring system 1 according to the present example embodiment is as illustrated in FIG. 7. FIG. 8 illustrates a configuration example of the remote monitoring system 1 according to the present example embodiment. Note that the configuration of each apparatus is an example, and another configuration may be used as long as the operation according to the present example embodiment described below can be performed. For example, some functions of the terminal 100 may be disposed in the center server 200 or another apparatus, or some functions of the center server 200 may be disposed in the terminal 100 or another apparatus. In addition, the functions of the MEC 400 including the compression bit rate control function may be disposed in the center server 200 or the like.

As illustrated in FIG. 8, the terminal 100 according to the present example embodiment includes a video acquisition unit 110, an encoder 120, and a terminal communication unit 130.

The video acquisition unit 110 acquires a video captured by the camera 101. The video captured by the camera is hereinafter also referred to as an input video. For example, the input video includes a person who is a worker who performs work at a site. The video acquisition unit 110 is also an image acquisition unit that acquires a plurality of time-series images, that is, frames.

The encoder 120 encodes the acquired input video. The encoder 120 is an encoding unit that encodes an input video. The encoder 120 is also a compression unit that compresses an input video by a predetermined encoding system. The encoder 120 performs encoding by a video encoding system such as H.264 or H.265, for example. The encoder 120 may detect an ROI including a person and encode the input video such that the detected ROI has higher image quality than other regions.

An ROI specifying unit may be provided between the video acquisition unit 110 and the encoder 120. The ROI specifying unit detects an object in the acquired video, and specifies a region such as the ROI. The encoder 120 may encode the input video such that the ROI specified by the ROI specifying unit has higher image quality than other regions. In addition, the input image may be encoded such that the image quality of the region designated by the ROI specifying unit is lower than that of other regions. In a case of detecting or specifying the ROI, the ROI specifying unit or the encoder 120 may hold information in which an object that may appear in a video is associated with its priority, and specify a region such as the ROI according to the correspondence information of the priority.

The encoder 120 encodes the input video at a predetermined bit rate. The encoder 120 may encode the input video at a bit rate, a frame rate, or the like allocated from the compression bit rate control function 401 of the MEC 400. In addition, the encoder 120 may determine the bit rate, the frame rate, or the like on the basis of the communication quality between the terminal 100 and the center server 200. The communication quality is, for example, a communication speed, but may be another index such as a transmission delay or an error rate. The terminal 100 may include a communication quality measurement unit that measures communication quality. For example, the communication quality measurement unit determines the bit rate of the video to be transmitted from the terminal 100 to the center server 200 according to the communication speed. The communication speed may be measured on the basis of the data amount received by the base station 300 or the center server 200, and the communication quality measurement unit may acquire the measured communication speed from the base station 300 or the center server 200. In addition, the communication quality measurement unit may estimate the communication speed on the basis of the data amount per unit time transmitted from the terminal communication unit 130.

The terminal communication unit 130 transmits encoded data (compressed data) encoded by the encoder 120 to the center server 200 via the base station 300. The terminal communication unit 130 is a transmission unit that transmits the acquired input video via the network. The terminal communication unit 130 is an interface capable of communicating with the base station 300, and is, for example, a wireless interface such as 4G, local 5G/5G, LTE, or a wireless LAN, but may be a wireless or wired interface of any other communication system.

In addition, as illustrated in FIG. 8, the center server 200 according to the present example embodiment includes recognition models M11 and M12, a center communication unit 210, a decoder 220, a prediction unit 230, a determination unit 240, a switching unit 250, and a storage unit 260.

The recognition models M11 and M12 execute video recognition processing on an input video. In this example, the video recognition processing is executed on the received video that is received and decoded from the terminal. The video recognition processing is, for example, behavior recognition processing of recognizing the behavior of a person in the video, but may be other recognition processing. The recognition models M11 and M12 detect an object from the received video, recognize the behavior of the detected object, and output a result of the behavior recognition.

The recognition models M11 and M12 are video recognition engines using machine learning such as deep learning. By performing machine learning of the feature of the video of the person performing work and behavior labels, it is possible to recognize the behavior of the person in the video. For example, the recognition models M11 and M12 are learning models that can learn and predict on the basis of time-series video data, and may be convolutional neural networks (CNNs), recurrent neural networks (RNNs), or other neural networks.

The recognition model M11 and the recognition model M12 are models that learn videos of different video recognition environments as learning data, and are learning models for analyzing videos of different video recognition environments. The recognition model M11 learns the video of the first video recognition environment, and the recognition model M12 learns the video of the second video recognition environment. The recognition models M11 and M12 can accurately analyze the video of the learned video recognition environment. Therefore, in a case where the video recognition environment of the received video is the video of the first video recognition environment, the received video is analyzed using the recognition model M11, and in a case where the video recognition environment of the received video is the video of the second video recognition environment, the received video is analyzed using the recognition model M11, so that the video can be analyzed with high accuracy.

The video recognition environment is, for example, a video parameter related to video quality such as a bit rate and a frame rate. Not limited to the bit rate or the frame rate, a compression rate or image resolution may be used. In the present example embodiment, an example of the bit rate will be described. The recognition model M11 learns the video with a first bit rate range, and the recognition model M12 learns the video with a second bit rate range. Note that, without being limited to the first bit rate range and the second bit rate range, a first bit rate and a second bit rate may be used. For example, the first bit rate range is a bit rate range higher than the second bit rate range, the recognition model M11 is a model for a high bit rate, and the recognition model M12 is a model for a low bit rate, but the present invention is not limited thereto. Note that the first bit rate range and the second bit rate range may partially overlap.

The center communication unit 210 receives the encoded data transmitted from the terminal 100 via the base station 300. The center communication unit 210 is a reception unit that receives the input video acquired by the terminal 100 via the network. The center communication unit 210 is an interface capable of communicating with the Internet or a core network, and is, for example, a wired interface for IP communication, but may be a wired or wireless interface of any other communication system.

The decoder 220 decodes the encoded data received from the terminal 100. The decoder 220 is a decoding unit that decodes the encoded data. The decoder 220 is also a restoration unit that restores the encoded data, that is, the compressed data by a predetermined encoding system. The decoder 220 is compatible with the encoding system of the terminal 100, and performs decoding by a moving image encoding system such as H.264 or H.265. The decoder 220 decodes the video according to the compression rate or the bit rate of each region, and generates a decoded video. The decoded video is hereinafter also referred to as a received video.

The prediction unit 230 predicts a change in the video recognition environment of the decoded received video. The prediction unit 230 extracts the information regarding the video recognition environment from the received video, and monitors the extracted information to predict the change in the video recognition environment. For example, the prediction unit 230 predicts a change in the bit rate extracted from the received video.

The determination unit 240 determines the recognition model for analyzing the received video, according to the video recognition environment of the received video, and determines the switching timing of the recognition model according to the predicted change in the video recognition environment. For example, the determination unit 240 determines a recognition model for analyzing the received video, according to the bit rate extracted from the received video. In addition, the determination unit 240 determines the recognition model as the switching destination and the switching timing on the basis of the change in the bit rate predicted by the prediction unit 230. Furthermore, the determination unit 240 determines a pre-input timing at which the video data is input in advance to the recognition model as the switching destination at the time of the switching, on the basis of the switching timing of the recognition model. The pre-input timing is a timing at which the input of the video data to the recognition model as the switching destination is started preceding the switching timing by the predetermined period.

For example, the pre-input timing may be determined on the basis of the number of pre-input frames input to the recognition model in advance. The number of pre-input frames is the number of frames used by the recognition model as the switching destination to perform video recognition. The number of pre-input frames is also the number of frames input to both the two recognition models at the time of switching. Since the number of pre-input frames varies depending on the recognition model as the switching destination, the number of pre-input frames is set in advance for each recognition model. For example, the number of pre-input frames may be changed according to the required recognition accuracy. In addition, a predetermined period corresponding to the number of pre-input frames may be associated with each recognition model.

The switching unit 250 switches the recognition models M11 and M12 for analyzing the decoded received video. The switching unit 250 selects the recognition model on the basis of the recognition model determined by the determination unit 240, and inputs the received video to the selected recognition model. The switching unit 250 switches the recognition model to which the received video is input, on the basis of the determined recognition model as the switching destination and the switching timing. The switching unit 250 inputs the video to the recognition model as the switching destination before the switching timing on the basis of the determined pre-input timing. The switching unit 250 inputs the video to both the recognition model before the switching and the recognition model after the switching during a period from the pre-input timing to the switching timing.

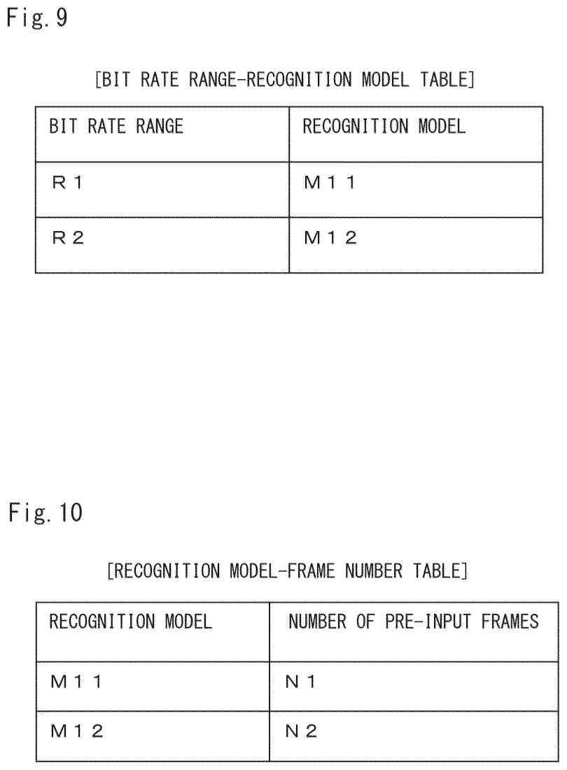

The storage unit 260 stores data required for processing of the center server 200. The storage unit 260 stores a video recognition environment-recognition model table in which a video recognition environment and a recognition model are associated with each other. FIG. 9 illustrates a specific example of a bit rate range-recognition model table in which a bit rate range and a recognition model are associated with each other as an example of the video recognition environment-recognition model table. With the bit rate range-recognition model table, it is possible to select a recognition model for analyzing a video according to a bit rate of the video. In this example, a bit rate range R1 and the recognition model M11 are associated, and a bit rate range R2 and the recognition model M12 are associated. The bit rate ranges R1 and R2 correspond to the bit rate ranges of the video learned by each recognition model, for example, the bit rate range R1 is a high bit rate range higher than the bit rate range R2, and the bit rate range R2 is a low bit rate range lower than the bit rate range R1.

In addition, the storage unit 260 stores a recognition model-frame number table in which a recognition model and the number of pre-input frames are associated with each other. FIG. 10 illustrates a specific example of a recognition model-frame number table. With the recognition model-frame number table, it is possible to determine the number of pre-input frames according to the recognition model as the switching destination. In this example, the number of frames N1 is associated with the recognition model M11, and the number of frames N2 is associated with the recognition model M12. Note that, not limited to the number of frames, a pre-input time that is a predetermined period corresponding to the number of frames to be input in advance may be associated with the recognition model, and the pre-input timing may be determined from the pre-input time according to the recognition model as the switching destination.

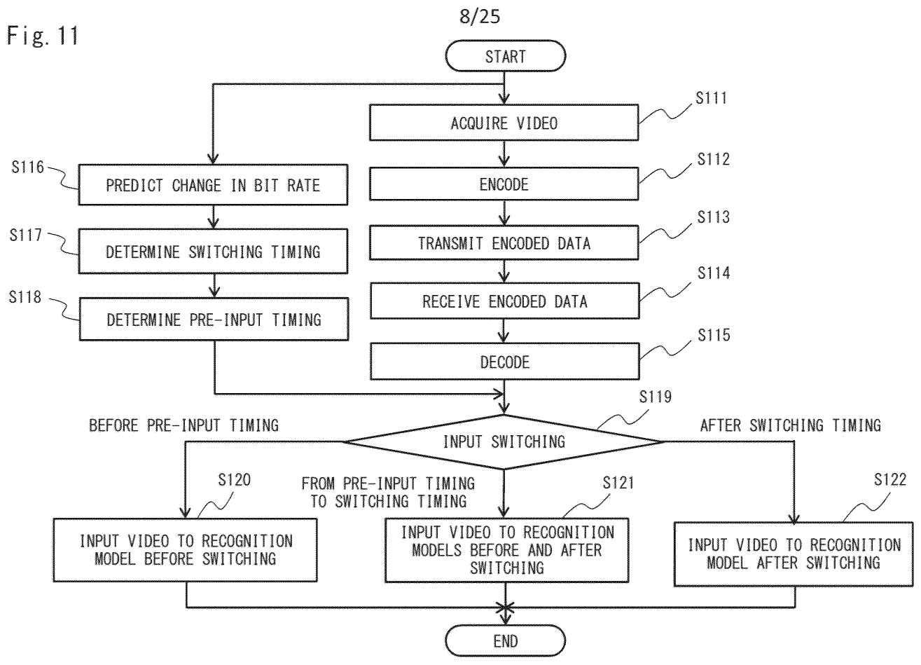

Next, an operation of the remote monitoring system according to the present example embodiment will be described. FIG. 11 illustrates an operation example of the remote monitoring system 1 according to the present example embodiment. For example, it is described that the terminal 100 executes S111 to S113 and the center server 200 executes S114 to S122, but the present invention is not limited thereto, and any apparatus may execute each processing.

Some functions of the center server 200 may be arranged in another apparatus, and the other apparatus may execute the functions. For example, the terminal 100 or the MEC 400 may include the prediction unit 230, the determination unit 240, the switching unit 250, and the storage unit 260. The terminal 100 or the MEC 400 may predict a change in the video recognition environment on the basis of the acquired change in the video and the communication quality, determine the recognition model and the switching timing with reference to the information of the storage unit, and notify the center server 200 of the instruction of the switching timing. Note that, not limited to the present example embodiment, as in other example embodiments, the terminal 100 or the MEC 400 may include the prediction unit 230, the determination unit 240, the switching unit 250, and the storage unit 260.

As illustrated in FIG. 11, the terminal 100 acquires a video from the camera 101 (S111). The camera 101 generates a video obtained by imaging the site, and the video acquisition unit 110 acquires a video (input video) output from the camera 101. For example, the image of the input video includes a person who performs work at a site, an object used for work, and the like.

Subsequently, the terminal 100 encodes the acquired input video (S112). The encoder 120 encodes the input video by a predetermined video encoding system. For example, the encoder 120 may encode the input video at a bit rate allocated from the compression bit rate control function 401 of the MEC 400, or may encode the input video at a bit rate according to the communication quality between the terminal 100 and the center server 200.

Subsequently, the terminal 100 transmits the encoded data, that is encoded, to the center server 200 (S113), and the center server 200 receives the encoded data (S114).

The terminal communication unit 130 transmits encoded data obtained by encoding the input video, to the base station 300. The base station 300 transfers the received encoded data to the center server 200 via the core network or the Internet. The center communication unit 210 receives the transferred encoded data from the base station 300.

Subsequently, the center server 200 decodes the received encoded data (S115). The decoder 220 decodes the encoded data according to the compression rate or the bit rate of each region, and generates a decoded video, that is, a received video.

In addition, the center server 200 predicts a change in the bit rate of the received video (S116). As an example of the video recognition environment, the prediction unit 230 monitors the bit rate of the received video and predicts a change in the bit rate. For example, the prediction unit 230 measures a data amount per unit time in the encoded data received by the center communication unit 210, and acquires a bit rate. The terminal 100 may transmit a packet including the encoded data and the bit rate, and the prediction unit 230 may acquire the bit rate from the received packet. The prediction unit 230 extracts the tendency of transition of the bit rate on the basis of the history of the past bit rates acquired periodically, and predicts a change in the subsequent bit rate.

Subsequently, the center server 200 determines the switching timing (S117). The determination unit 240 determines the recognition model as the switching destination and the switching timing according to the predicted change in the bit rate. The determination unit 240 refers to the bit rate range-recognition model table in the storage unit 260, and determines the recognition model corresponding to the predicted bit rate. In the example of the bit rate range-recognition model table of FIG. 9, in a case where it is predicted that the bit rate of the received video is changed from the bit rate range R1 to the bit rate range R2, it is determined to switch the recognition model from M11 to M12, and the timing at which the bit rate is changed from the bit rate range R1 to the bit rate range R2 is determined as the switching timing. For example, the predicted bit rate is compared with the center of the bit rate range R1 and the center of the bit rate range R2, and the timing at which the predicted bit rate is changed from a state close to the center of the bit rate range R1 to a state close to the center of the bit rate range R2 is set as the switching timing.

Subsequently, the center server 200 determines the pre-input timing (S118). The determination unit 240 determines the pre-input timing at which the video data is input in advance to the recognition model as the switching destination at the time of the switching, on the basis of the determined switching timing of the recognition model. The determination unit 240 refers to the recognition model-frame number table in the storage unit 260, and determines the number of pre-input frames according to the recognition model as the switching destination. In the example of the recognition model-frame number table in FIG. 10, in a case where the recognition model as the switching destination is M12, it is determined that the number of pre-input frames is N2. Furthermore, the pre-input time corresponding to the number of pre-input frames N2 is calculated on the basis of the frame rate, and the pre-input time is subtracted from the switching timing to determine the pre-input timing.

Subsequently, the center server 200 switches the input of the received video to the recognition model (S119). The switching unit 250 selects the recognition model according to the determined pre-input timing and switching timing, and inputs the decoded received video to the selected recognition model (S120 to S122).

Specifically, in a case where the current time point is before the pre-input timing, the switching unit 250 inputs the received video to the recognition model before the switching (S120). For example, the switching unit 250 inputs the received video (frame) only to the recognition model M11 before the switching. The recognition model M11 performs video recognition using the input received video.

In addition, in a case where the current time point is between the pre-input timing and the switching timing, the switching unit 250 inputs the received video to the recognition models before and after the switching (S121). For example, the switching unit 250 inputs the frame of the received video to both the recognition model M11 before the switching and the recognition model M12 after the switching. The recognition model M11 performs video recognition using the received video input from S120, and outputs the recognition result. The recognition model M12 starts the video recognition processing using the received video input from S121, or makes the video recognition processing possible.

In addition, in a case where the current time point is after the switching timing, the switching unit 250 inputs the received video to the recognition model after the switching (S122). For example, the switching unit 250 inputs the frame of the received video only to the recognition model M12 after the switching. The recognition model M12 performs video recognition using the received video input from S121, and outputs the recognition result. Note that the same operation is performed also in a case where the recognition model M12 is switched to the recognition model M11.

In addition, in a case where the switching becomes unnecessary in a stage (S121) where the video is input to both the recognition models in the middle of the switching, the recognition model may return to the original recognition model. That is, it is not necessary to switch to the recognition model as the switching destination. In a case where a decrease in the bit rate is predicted and the video starts to be input to both the recognition models, but it is predicted that the bit rate is not changed due to a change in a situation (or immediately recovers even in a case of a decrease in the bit rate), switching may be interrupted and the recognition model may return to the original recognition model.

Note that the processing flow illustrated in FIG. 11 is an example, and the order of each processing is not limited thereto. The order of part of the processing may be changed and executed, or part of the processing may be executed in parallel. For example, in a case where the terminal 100 or the MEC 400 includes the prediction unit 230, the determination unit 240, the switching unit 250, and the storage unit 260, S116 to S118 may be executed between S111 and S112. In addition, S116 to S118 may be executed in parallel with S111 to S115 before input switching.

As described above, in the present example embodiment, in the remote monitoring system, the change in the bit rate of the video is predicted, and the recognition model for analyzing the video is switched according to the predicted change in the bit rate. In addition, a frame slightly before the switching is input to both the recognition models before and after the switching. As a result, the recognition model can be appropriately selected according to the change in the bit rate, and the recognition accuracy in the recognition model as the switching destination can be improved as compared with the case of simply switching the video input destination as illustrated in FIG. 5.

### Second Example Embodiment

Next, a second example embodiment will be described. In the present example embodiment, an example in which a video is input to a recognition model as a switching destination using a buffer will be described.

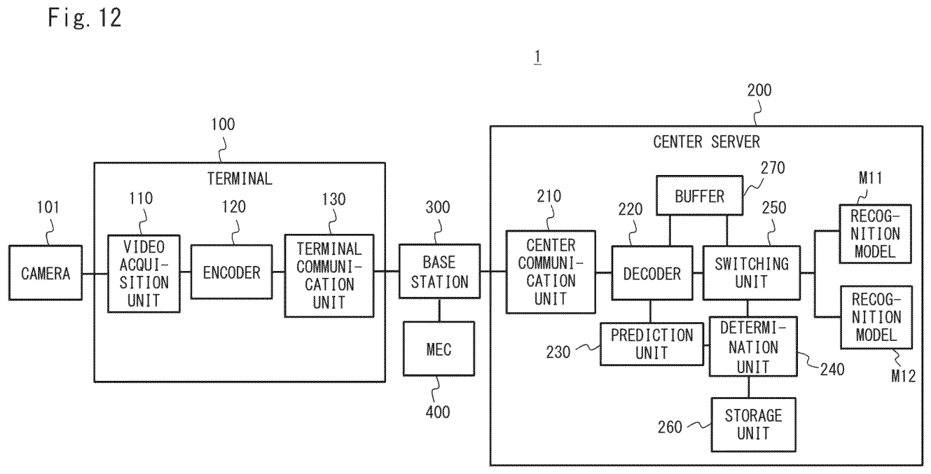

FIG. 12 illustrates a configuration example of the remote monitoring system 1 according to the present example embodiment. As illustrated in FIG. 12, in the present example embodiment, the center server 200 includes a buffer 270 in addition to the configuration of the first example embodiment. Other configurations are similar to those of the first example embodiment. Here, a configuration different from that of the first example embodiment will be mainly described.

The buffer 270 buffers the received video decoded by the decoder 220. The buffer 270 holds the frames in the number of frames necessary for the video recognition by each recognition model. The frames in the required number of pre-input frames may be held for each recognition model, or the frames in the largest number of frames among the number of pre-input frames required by each recognition model may be held.

When switching the recognition model, the switching unit 250 acquires the frame held in the buffer 270, and inputs the received video including the acquired frame to the recognition model before the switching. The switching unit 250 acquires the frames in the number of pre-input frames required for the recognition model after the switching, from the buffer 270, and inputs the received video including the acquired frames to the recognition model after the switching. For example, buffer sizes of a plurality of buffers may be set according to the number of pre-input frames of each recognition model, and the frames in the number of pre-input frames may be acquired from the buffer corresponding to the recognition model. In addition, the video including the frame held in the buffer 270 at the switching timing may be input to the recognition model after the switching. In this case, it is not necessary to input the video from the pre-input timing as in the first example embodiment.

As described above, the remote monitoring system of the first example embodiment may further include a buffer, and the frame held in the buffer may be input to the recognition model as the switching destination. As a result, as in the first example embodiment, the recognition accuracy in the recognition model as the switching destination can be improved.

### Third Example Embodiment

Next, a third example embodiment will be described. In the present example embodiment, an example of switching recognition models according to a change in a frame rate of a video will be described.

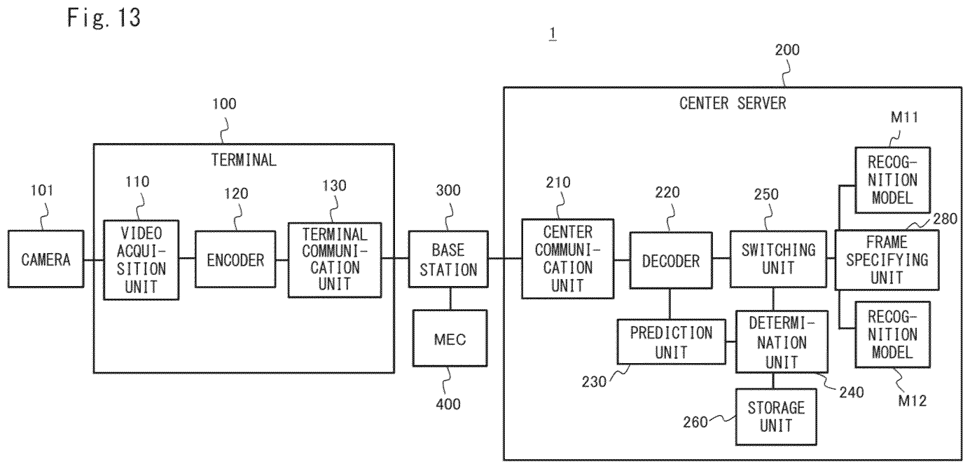

FIG. 13 illustrates a configuration example of the remote monitoring system 1 according to the present example embodiment. As illustrated in FIG. 13, in the present example embodiment, the center server 200 includes a frame specifying unit 280 in addition to the configuration of the first example embodiment. Other configurations are similar to those of the first example embodiment. Note that the present example embodiment may be applied to the second example embodiment. Here, a configuration different from that of the first example embodiment will be mainly described.

In the present example embodiment, the recognition models M11 and M12 are recognition models that have learned videos with different frame rates. The recognition model M11 learns a video with a first frame rate, and the recognition model M12 learns a video of a second frame rate. For example, the first frame rate is a frame rate higher than the second frame rate, the recognition model M11 is a model for a high frame rate, and the recognition model M12 is a model for a low frame rate, but the present invention is not limited thereto. Note that, without being limited to the first frame rate and the second frame rate, a first frame rate range and a second frame rate range may be used.

Note that the recognition model may learn and analyze a video combining a predetermined bit rate and a predetermined frame rate. A plurality of recognition models may learn and analyze videos of combinations of different bit rates and frame rates. In this case, the recognition model is selected and switched according to the bit rate and the frame rate of the video.

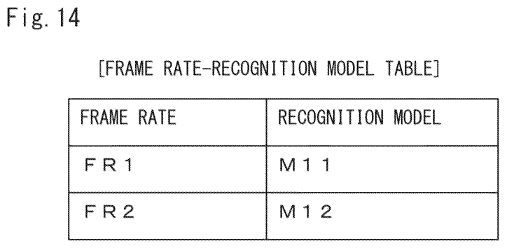

As an example of the video recognition environment-recognition model table, the storage unit 260 stores a frame rate-recognition model table in which a frame rate and a recognition model are associated with each other. FIG. 14 illustrates a specific example of the frame rate-recognition model table. In this example, a frame rate FR1 and the recognition model M11 are associated, and a frame rate FR2 and the recognition model M12 are associated. The frame rates FR1 and FR2 correspond to the frame rates of the video learned by each recognition model, for example, the frame rate FR1 is a high frame rate higher than the frame rate FR2, and the frame rate FR2 is a low frame rate lower than the frame rate FR1.

The prediction unit 230 monitors the frame rate of the received video and predicts a change in the frame rate. For example, the prediction unit 230 acquires the frame rate included in the header of the encoded data. Not only the header of the encoded data but also a packet including the encoded data and the frame rate may be transmitted from the terminal 100 to the center communication unit 210, and the prediction unit 230 may acquire the frame rate from the received packet. The prediction unit 230 extracts the tendency of transition of the frame rate on the basis of the history of the past frame rates acquired periodically, and predicts a change in the subsequent frame rate.

Note that, in a case where the terminal 100 includes the prediction unit 230, a change in the frame rate may be predicted according to an instruction from the MEC 400 or a frame rate determined on the basis of the measurement by the communication quality measurement unit of the terminal 100.

The determination unit 240 determines the recognition model as the switching destination and the switching timing according to the predicted change in the frame rate. The determination unit 240 refers to the frame rate-recognition model table in the storage unit 260, and determines the recognition model corresponding to the predicted frame rate. In the example of the frame rate-recognition model table of FIG. 14, in a case where it is predicted that the frame rate is changed from FR1 to FR2, it is determined to switch the recognition model from M11 to M12, and the timing at which the frame rate is changed from FR1 to FR2 is determined as the switching timing. For example, the predicted frame rate is compared with FR1 and FR2, and the timing at which the predicted frame rate is changed from a state close to FR1 to a state close to FR2 is set as the switching timing. In a case where the frame rates FR1 and FR2 include a range of frame rates, the frame rates may be compared with the center of the range, or may be compared with any value of the range. In addition, as in the first example embodiment, the determination unit 240 determines the pre-input timing on the basis of the number of pre-input frames corresponding to the recognition model as the switching destination and the learned frame rate of the recognition model as the switching destination.

The frame specifying unit 280 specifies a frame interval, that is, the frame rate of the video input to the recognition model, according to the recognition model selected by the switching unit 250. The frame specifying unit 280 specifies the frame interval, for example, by adjusting the frame interval. The frame specifying unit 280 performs frame thinning and frame interpolation in a case where the frame rates of the video input to the recognition models before and after the switching are different. The frame interpolation is insertion of a frame between frames of a video. Note that the frame interval may be specified in any of a case before the pre-input timing, a case from the pre-input timing to the switching timing, and a case after the switching timing. For example, the frame specifying unit 280 refers to the frame rate-recognition model table of the storage unit 260, adjusts the frame interval of the video to be input, on the basis of the difference between the frame rate of the video to be input and the learned frame rate or range of the frame rate of the selected recognition model, and inputs the adjusted video to the recognition model. In a case where the frame rate of the video is lower than the learned frame rate of the recognition model, the frame interpolation is performed in accordance with the learned frame rate of the recognition model. A method of the frame interpolation is not limited. For example, the same frame as the frame before or after the frame is inserted may be inserted, or the frame estimated according to the change in the image in the past frames may be inserted. In a case where the frame rate of the video is higher than the learned frame rate of the recognition model, the frames are thinned out in accordance with the learned frame rate of the recognition model. Note that, similarly to the prediction unit 230 or the like, the terminal 100 or the MEC 400 may include the frame specifying unit 280.

For example, it is assumed that the recognition model M11 is a recognition model that has learned a video with a frame rate of 10 fps, and the recognition model M12 is a recognition model that has learned a video with a frame rate of 30fps. At this time, in a case of inputting a video with a frame rate of 10 fps by switching the recognition model M11 to the recognition model M12, the frame specifying unit 280 performs the frame interpolation on the video to be input, and inputs the video that is frame-interpolated to 30 fps, to the recognition model M12. In a case of inputting a video with a frame rate of 30 fps by switching the recognition model M12 to the recognition model M11, the frame specifying unit 280 thins the video to be input, and inputs the video that is thinned out to 10 fps, to the recognition model M11.

As described above, in the remote monitoring system of the first example embodiment, the change in the frame rate of the video is predicted, and the recognition model for analyzing the video may be switched according to the predicted change in the frame rate. As a result, the recognition model can be appropriately selected according to the change in the frame rate, and the recognition accuracy in the recognition model as the switching destination can be improved as in the first example embodiment. In addition, by adjusting and specifying the frame interval to be input according to the recognition model, it is possible to input a video at a frame rate suitable for the recognition model, and to improve the recognition accuracy.

### Fourth Example Embodiment

Next, a fourth example embodiment will be described. In the present example embodiment, an example of switching the recognition model according to a change in communication quality for receiving a video, as the change in the video recognition environment, will be described.

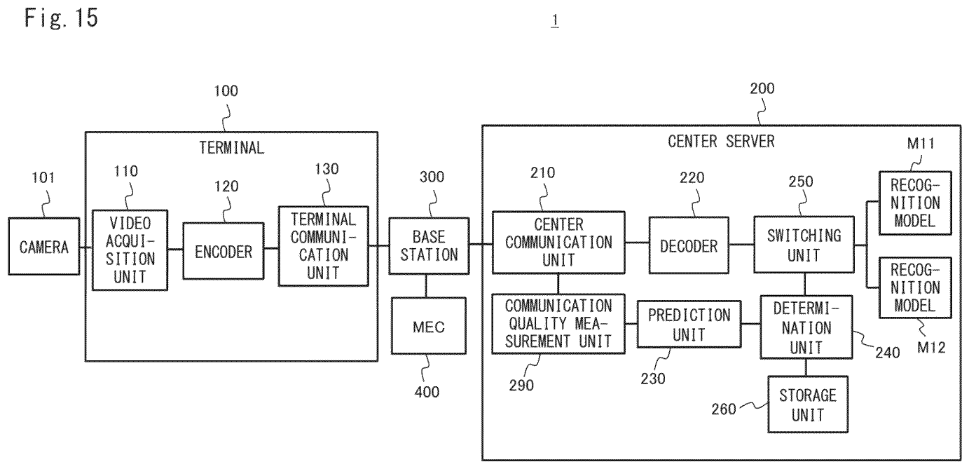

FIG. 15 illustrates a configuration example of the remote monitoring system 1 according to the present example embodiment. As illustrated in FIG. 15, in the present example embodiment, the center server 200 includes a communication quality measurement unit 290 in addition to the configuration of the first example embodiment. Other configurations are similar to those of the first example embodiment. Note that the present example embodiment may be applied to other example embodiments. For example, as in the first example embodiment, the recognition model M11 learns the video with the first bit rate range, and the recognition model M12 learns the video with the second bit rate range. The present invention is not limited thereto, and the recognition models M11 and M12 may learn videos with different frame rates as in the third example embodiment. In addition, the recognition models M11 and M12 may learn videos corresponding to different communication qualities. Here, a configuration different from that of the first example embodiment will be mainly described.

The communication quality measurement unit 290 measures the communication quality between the terminal 100 and the center server 200. The communication quality is a communication quality of a reception path through which the center server 200 receives the video from the terminal 100. The communication quality is, for example, a communication speed, but may be another index such as a transmission delay or an error rate. For example, the communication speed is measured on the basis of the data amount per unit time received by the center communication unit 210. Note that the base station 300, the terminal 100, or the MEC 400 may include a communication quality measurement unit, and the communication quality measured or estimated by the communication quality measurement unit of the base station 300, the terminal 100, or the MEC 400 may be acquired.

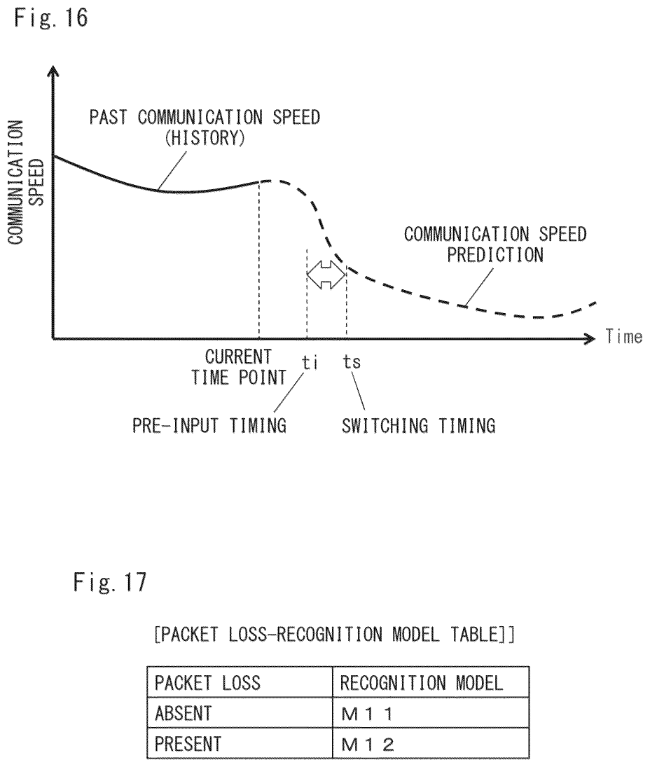

The prediction unit 230 predicts a change in the communication quality as the change in the video recognition environment. The prediction unit 230 periodically acquires the communication quality measured by the communication quality measurement unit 290, extracts the tendency of transition of the communication quality on the basis of the history of the acquired past communication quality, and predicts a change in the subsequent communication quality. FIG. 16 illustrates a prediction example of the communication speed. As illustrated in FIG. 16, a future change in the communication speed is predicted from the history of the past communication speed.

The determination unit 240 determines the recognition model as the switching destination and the switching timing according to the predicted change in the communication quality. In a case where the recognition models M11 and M12 learn a video for each bit rate, the recognition model as the switching destination and the switching timing are determined on the basis of the bit rate corresponding to the communication quality. For example, the determination unit 240 estimates the bit rate of the received video from the predicted communication speed. Since the terminal 100 on the transmission side determines and encodes the bit rate according to the communication quality, the center server 200 on the reception side also determines the bit rate according to the communication quality similarly to the terminal 100, and estimates the bit rate encoded by the terminal 100. For example, the bit rate can be estimated from the communication speed by associating the communication speed with the estimated bit rate. The determination unit 240 determines the recognition model as the switching destination and the switching timing according to the change in the estimated bit rate as in the first example embodiment. In the example of FIG. 16, ts at which the bit rate is changed to a predetermined value or less according to the communication speed is determined as the switching timing. In addition, as in the first example embodiment, the pre-input timing ti is determined on the basis of the switching timing. In a case where the recognition models M11 and M12 learn a video for each communication quality, the recognition model corresponding to the predicted communication quality is used as a recognition model as the switching destination.

As described above, in the remote monitoring system of the first example embodiment, a change in the communication quality of receiving the video may be predicted, and the recognition model for analyzing the video may be switched according to the predicted change in the communication quality. As a result, the recognition model can be appropriately selected according to the change in the communication quality, and the recognition accuracy in the recognition model as the switching destination can be improved as in the first example embodiment.

### Fifth Example Embodiment

Next, a fifth example embodiment will be described. In the present example embodiment, as the communication quality included in the video recognition environment, an example of switching the recognition model according to the packet loss of the packet for receiving the video will be described. The configuration of the remote monitoring system 1 according to the present example embodiment is similar to the configuration in FIG. 15 according to the fourth example embodiment. Here, a configuration different from that of the fourth example embodiment will be mainly described.

In the present example embodiment, the recognition models M11 and M12 are recognition models that have learned videos having different occurrence situations of packet loss as an example of the communication quality. For example, the recognition model M11 learns a video without packet loss, and the recognition model M12 learns a video with packet loss. The packet loss means that all or some packets for transmitting data of frames of a video cannot be normally received by the reception side and are missing. The packet may be missing for each frame, or the packet may be missing in a predetermined period. Note that, not limited to the presence or absence of the packet loss, the recognition model M11 may learn a video having a first packet loss rate, and the recognition model M12 may learn a video having a second packet loss rate. For example, the first packet loss rate may be lower than the second packet loss rate.

As an example of the video recognition environment-recognition model table, the storage unit 260 stores a packet loss-recognition model table in which an occurrence situation of packet loss and a recognition model are associated with each other. FIG. 17 illustrates a specific example of the packet loss-recognition model table. In this example, the recognition model M11 is associated with the absence of packet loss, and the recognition model M12 is associated with the presence of packet loss. In a case where the packet loss rate is associated, a range of the packet loss rate may be associated.

The communication quality measurement unit 290 measures an occurrence situation of packet loss, that is, presence or absence of packet loss as the communication quality. The center communication unit 210 monitors packets received, and measures whether or not a packet is missing in each frame.

The prediction unit 230 predicts an occurrence situation of packet loss. The prediction unit 230 periodically acquires the occurrence situation of the packet loss measured by the communication quality measurement unit 290, extracts the tendency of the packet loss on the basis of the occurrence history of the acquired past packet loss, and predicts the occurrence situation of the subsequent packet loss.

The determination unit 240 determines the recognition model as the switching destination and the switching timing according to the predicted occurrence situation of the packet loss. The determination unit 240 refers to the packet loss-recognition model table in the storage unit 260, and determines a recognition model corresponding to the predicted occurrence situation of the packet loss. In the example of the packet loss-recognition model table of FIG. 17, in a case where it is predicted that there is a change from the absence of packet loss to the presence of packet loss, it is determined to switch the recognition model from M11 to M12, and the timing at which there is a change from the absence of packet loss to the presence of packet loss is determined as the switching timing.

As described above, in the remote monitoring system of the fourth example embodiment, the change in the occurrence situation of the packet loss of the packet of receiving the video may be predicted, and the recognition model for analyzing the video may be switched according to the predicted change in the occurrence situation of the packet loss. As a result, the recognition model can be appropriately selected according to the change in the occurrence situation of the packet loss, and the recognition accuracy in the recognition model as the switching destination can be improved as in the fourth example embodiment.

### Sixth Example Embodiment

Next, a sixth example embodiment will be described. In the present example embodiment, an example of switching the recognition model according to a change in a scene where a video is captured, as the change in the video recognition environment, will be described.

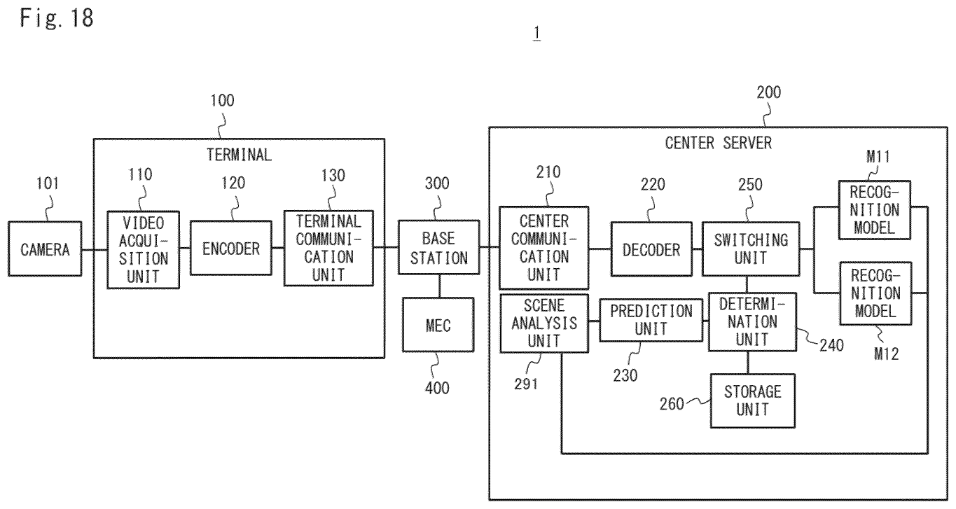

FIG. 18 illustrates a configuration example of the remote monitoring system 1 according to the present example embodiment. As illustrated in FIG. 18, in the present example embodiment, the center server 200 includes a scene analysis unit 291 in addition to the configuration of the first example embodiment. Other configurations are similar to those of the first example embodiment. Note that the present example embodiment may be applied to other example embodiments. Here, a configuration different from that of the first example embodiment will be mainly described.

In the present example embodiment, the recognition models M11 and M12 are recognition models that have learned videos with different scenes. The scene is the progress of a process at a construction site, work contents of a worker, a work place, or the like. For example, the recognition model M11 learns a video of a first work process, and the recognition model M12 learns a video of a second work process.

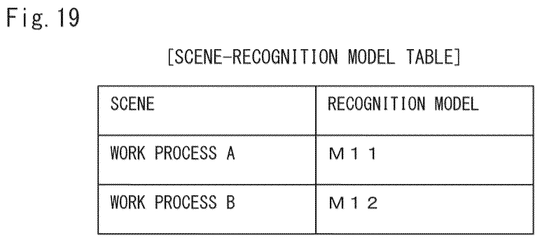

As an example of the video recognition environment-recognition model table, the storage unit 260 stores a scene-recognition model table in which a scene and a recognition model are associated with each other. FIG. 19 illustrates a specific example of the scene-recognition model table. In this example, a work process A and the recognition model M11 are associated with each other, and a work process B and the recognition model M12 are associated with each other.

The scene analysis unit 291 analyzes a scene of a video. For example, the scene analysis unit 291 analyzes the scene of the video on the basis of the recognition result of the recognition model M11 or M12. In a case where the recognition models M11 and M12 recognize the work content from the video, the work content and the work process may be associated in advance, and the work process may be determined from the recognized work content.

Note that the terminal 100 may include the scene analysis unit 291. In a case where the terminal 100 includes the scene analysis unit 291, the scene of the video may be analyzed on the basis of the video acquired by the video acquisition unit 110. For example, the terminal 100 may include an object detection unit, and the scene analysis unit 291 may analyze the scene on the basis of an object detected by the object detection unit and information regarding a correspondence between the object and the scene.

The prediction unit 230 predicts a change in the scene of the video. The prediction unit 230 periodically acquires the scene analyzed by the scene analysis unit 291, and predicts a change in the subsequent scene on the basis of the history of the acquired past scene. For example, schedule information of the work process is acquired, and the completion of the work, the next work content, and the next work process are predicted from the analyzed work content and work process on the basis of the schedule information. The schedule information may include time, work content, and the like of each work process.

The determination unit 240 determines the recognition model as the switching destination and the switching timing according to the predicted change in the scene. The determination unit 240 refers to the scene-recognition model table in the storage unit 260, and determines the recognition model corresponding to the predicted scene. In the example of the scene-recognition model table of FIG. 19, in a case where it is predicted that the work process is changed from the work process A to the work process B, it is determined to switch the recognition model from M11 to M12, and the timing at which the work process is changed from the work process A to the work process B is determined as the switching timing.

As described above, in the remote monitoring system of the first example embodiment, a change in the scene in which the video is captured may be predicted, and the recognition model for analyzing the video may be switched according to the predicted change in the scene. As a result, the recognition model can be appropriately selected according to the change in the scene, and the recognition accuracy in the recognition model as the switching destination can be improved as in the first example embodiment.

### Seventh Example Embodiment

Next, a seventh example embodiment will be described. In the present example embodiment, an example of switching the recognition model according to a change in the size of an object included in a video, as the change in the video recognition environment, will be described.

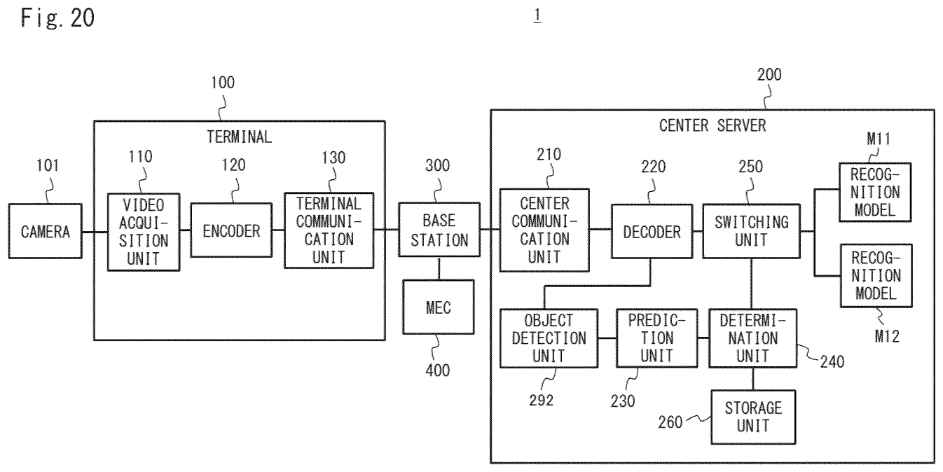

FIG. 20 illustrates a configuration example of the remote monitoring system 1 according to the present example embodiment. As illustrated in FIG. 20, in the present example embodiment, the center server 200 includes an object detection unit 292 in addition to the configuration of the first example embodiment. Other configurations are similar to those of the first example embodiment. Note that the present example embodiment may be applied to other example embodiments. Here, a configuration different from that of the first example embodiment will be mainly described.

In the present example embodiment, the recognition models M11 and M12 are recognition models that have learned videos in which the sizes of objects as the recognition target are different. The recognition model M11 learns the video of a first object size, and the recognition model M12 learns the video of a second object size. For example, the first object size is larger than the second object size, the recognition model M11 is a model for a large object, and the recognition model M12 is a model for a small object, but the present invention is not limited thereto. The size of the object, that is, the object size is the number of pixels of the region in which the object is shown in the image. For example, in a case where the object becomes closer to the camera, the size of the object is increased, and in a case where the object becomes farther from the camera, the size of the object is decreased. In addition, the size of the object is also changed according to the zoom of the camera.

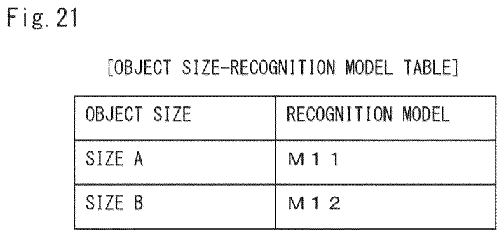

As an example of the video recognition environment-recognition model table, the storage unit 260 stores an object size-recognition model table in which a size of an object and a recognition model are associated with each other. FIG. 21 illustrates a specific example of the object size-recognition model table. In this example, a size A and the recognition model M11 are associated with each other, and a size B and the recognition model M12 are associated with each other. The sizes A and B may include a range of sizes of the object. The sizes A and B correspond to the object size of the video learned by each recognition model, for example, the size A is a size larger than the size B, and the size B is a size smaller than the size A.

The object detection unit 292 detects an object in the video. For example, the object detection unit 292 extracts a region including an object from each image of the video, and detects the object in the extracted region. The type of the object as the recognition target may be set in advance, and the size of the region of the object as the recognition target among the detected objects may be extracted as the size of the object. The object detection unit 292 may recognize an object in the image by an object recognition engine using machine learning. In addition, an object detection result may be acquired from the recognition model M11 or M12.

The prediction unit 230 predicts a change in the size of the object. The prediction unit 230 periodically acquires the size of the object detected by the object detection unit 292, extracts the tendency of transition of the size of the object on the basis of the history of the acquired past size of the object, and predicts a subsequent change in the size of the object. For example, a target object is tracked between frames of the video, sizes of the tracked object are compared, and a change in the size is predicted.

The determination unit 240 determines the recognition model as the switching destination and the switching timing according to the predicted change in the size of the object. The determination unit 240 refers to the object size-recognition model table in the storage unit 260, and determines the recognition model corresponding to the predicted size of the object. In the example of the object size-recognition model table of FIG. 21, in a case where it is predicted that the size of the object is changed from the size A to the size B, it is determined to switch the recognition model from M11 to M12, and the timing at which the size of the object is changed from the size A to the size B is determined as the switching timing. For example, the predicted size of the object is compared with the size A and the size B, and the timing at which the predicted size of the object is changed from a state close to the size A to a state close to the size B is set as the switching timing. In a case where the size A and the size B include a range of sizes, the size may be compared with the center of the range, or may be compared with any value of the range.

As described above, in the remote monitoring system of the first example embodiment, a change in the size of the object included in the video may be predicted, and the recognition model for analyzing the video may be switched according to the predicted change in the size of the object. As a result, the recognition model can be appropriately selected according to the change in the size of the object, and the recognition accuracy in the recognition model as the switching destination can be improved as in the first example embodiment.

### Eighth Example Embodiment

Next, an eighth example embodiment will be described. In the present example embodiment, an example of switching the recognition model according to a change in a motion speed of an object included in a video, as the change in the video recognition environment, will be described.

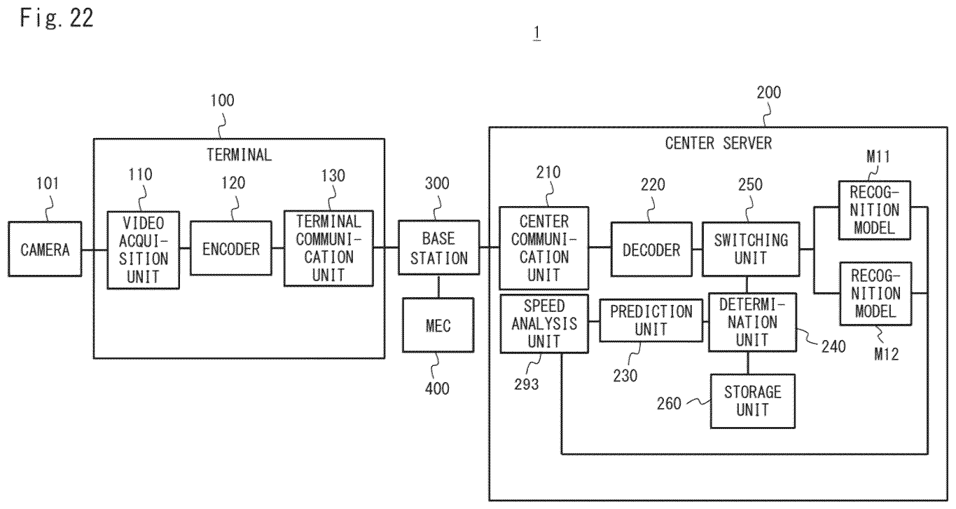

FIG. 22 illustrates a configuration example of the remote monitoring system 1 according to the present example embodiment. As illustrated in FIG. 22, in the present example embodiment, the center server 200 includes a speed analysis unit 293 in addition to the configuration of the first example embodiment. Other configurations are similar to those of the first example embodiment. Note that the present example embodiment may be applied to other example embodiments. Here, a configuration different from that of the first example embodiment will be mainly described.

In the present example embodiment, the recognition models M11 and M12 are recognition models that have learned videos in which the motion speeds of the objects as the recognition target are different. The recognition model M11 learns the video of an object at a first motion speed, and the recognition model M12 learns the video of an object at a second motion speed. The calculation amount of the recognition model also varies depending on the motion speed of the object to be recognized. For example, the first motion speed is lower than the second motion speed, the recognition model M11 is a low calculation amount model capable of recognizing only a low-speed motion, and the recognition model M12 is a high calculation amount model capable of recognizing even a high-speed motion, but the present invention is not limited thereto. Note that, without being limited to the first motion speed and the second motion speed, a first motion speed range and a second motion speed range may be used.

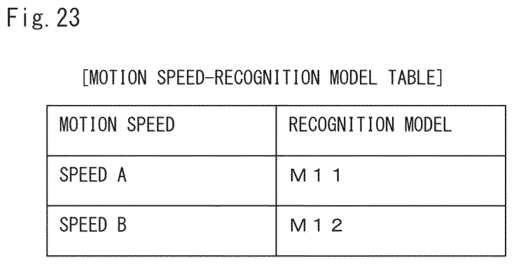

As an example of the video recognition environment-recognition model table, the storage unit 260 stores a motion speed-recognition model table in which a motion speed of an object and a recognition model are associated with each other. FIG. 23 illustrates a specific example of the motion speed-recognition model table. In this example, a speed A and the recognition model M11 are associated with each other, and a speed B and the recognition model M12 are associated with each other. The speeds A and B correspond to the motion speed of the video learned by each recognition model, and for example, the speed A is lower than the speed B, and the speed B is higher than the speed A.

The speed analysis unit 293 analyzes the motion speed of the object in the video. For example, the speed analysis unit 293 analyzes the motion speed on the basis of the recognition result of the recognition model M11 or M12. In a case where the recognition models M11 and M12 recognize the work content, the work content and the motion speed may be associated in advance, and the motion speed may be determined from the recognized work content. For example, in a case where it is recognized that a person walks, levels the ground, or the like, it is determined that the motion is a low-speed motion, and in a case where it is recognized that a person runs, throws an object, or the like, it is determined that the motion is a high-speed motion. For example, a target object in the video may be detected, the movement of the target object between frames may be extracted, and the speed may be determined from the extracted movement amount.

Note that the terminal 100 may include the speed analysis unit 293. In a case where the terminal 100 includes the speed analysis unit 293, the motion speed of the video may be analyzed on the basis of the video acquired by the video acquisition unit 110. For example, the terminal 100 may include the object detection unit, and the speed analysis unit 293 may analyze the motion speed on the basis of the movement of the object detected by the object detection unit.

The prediction unit 230 predicts a change in the motion speed of the object. The prediction unit 230 periodically acquires the motion speed of the object analyzed by the speed analysis unit 293, extracts the tendency of transition of the motion speed of the object on the basis of the history of the acquired past motion speed of the object, and predicts a subsequent change in the motion speed of the object.

The determination unit 240 determines the recognition model as the switching destination and the switching timing according to the predicted change in the motion speed of the object. The determination unit 240 refers to the motion speed-recognition model table in the storage unit 260, and determines the recognition model corresponding to the predicted motion speed of the object. In the example of the motion speed-recognition model table of FIG. 23, in a case where it is predicted that the motion speed of the object is changed from the speed A to the speed B, it is determined to switch the recognition model from M11 to M12, and the timing at which the motion speed is changed from the speed A to the speed B is determined as the switching timing.

As described above, in the remote monitoring system of the first example embodiment, a change in the motion speed of the object included in the video may be predicted, and the recognition model for analyzing the video may be switched according to the predicted change in the motion speed of the object. As a result, the recognition model can be appropriately selected according to the change in the motion speed of the object, both the low-speed motion and the high-speed motion can be recognized with the minimum calculation amount, and the recognition accuracy in the recognition model as the switching destination can be improved as in the first example embodiment.

### Ninth Example Embodiment

Next, a ninth example embodiment will be described. In the present example embodiment, an example of switching the recognition model according to a change in an imaging state of a video, as the change in the video recognition environment, will be described.

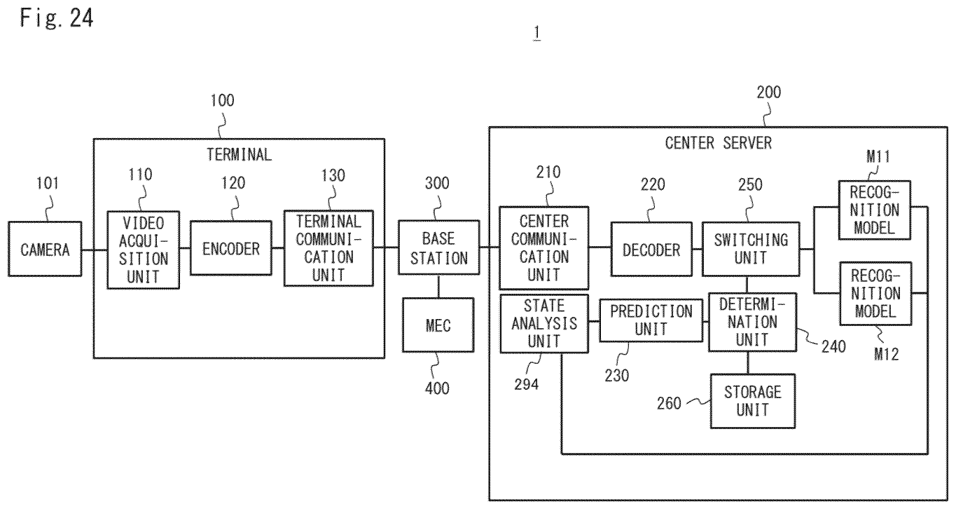

FIG. 24 illustrates a configuration example of the remote monitoring system 1 according to the present example embodiment. As illustrated in FIG. 24, in the present example embodiment, the center server 200 includes a state analysis unit 294 in addition to the configuration of the first example embodiment. Other configurations are similar to those of the first example embodiment. Note that the present example embodiment may be applied to other example embodiments. Here, a configuration different from that of the first example embodiment will be mainly described.

In the present example embodiment, the recognition models M11 and M12 are models that learn videos having different imaging states of the video. The imaging state includes fixed imaging in which a fixed camera performs imaging from a fixed position, moving imaging in which a moving camera performs imaging from moving positions. For example, the recognition model M11 learns a video captured by fixed imaging, and the recognition model M12 learns a video captured by moving imaging. Note that, without being limited to the fixed imaging/moving imaging, the recognition model M11 may learn a video captured by moving at a first moving speed, for example, a low-speed movement, and the recognition model M12 may learn a video captured by moving at a second moving speed, for example, a high-speed movement.

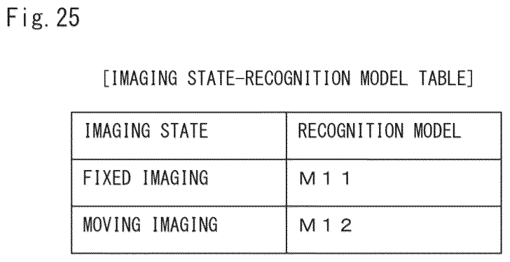

As an example of the video recognition environment-recognition model table, the storage unit 260 stores an imaging state-recognition model table in which an imaging state and a recognition model are associated with each other. FIG. 25 illustrates a specific example of the imaging state-recognition model table. In this example, the fixed imaging and the recognition model M11 are associated with each other, and the moving imaging and the recognition model M12 are associated with each other. In a case where the moving speed is associated, a range of the moving speed may be associated.

The state analysis unit 294 analyzes the imaging state of the video. The state analysis unit 294 may detect an imaging state such as fixed imaging or moving imaging on the basis of the recognition result of the recognition model M11 or M12. For example, in a case where the camera is an in-vehicle on-board camera and a traffic light at an intersection is shown in the video, the imaging state may be determined according to a color of the traffic light in front. In addition, in the case of the in-vehicle on-board camera, the imaging state may be detected according to control information of the vehicle acquired from the vehicle or operation information of the user. For example, the imaging state may be determined according to speed information of the vehicle, on/off of the engine, operation of a shift lever, a brake pedal, and an accelerator pedal.

Note that the terminal 100 may include the state analysis unit 294. In a case where the terminal 100 includes the state analysis unit 294, the imaging state of the video may be analyzed on the basis of the video acquired by the video acquisition unit 110. For example, the terminal 100 may include the object detection unit, and the state analysis unit 294 may analyze the imaging state on the basis of the color or movement of the object detected by the object detection unit.

The prediction unit 230 predicts a change in the imaging state of the video. The prediction unit 230 periodically acquires the imaging state analyzed by the state analysis unit 294, and predicts a change in the subsequent imaging state on the basis of the history of the acquired past imaging state. For example, in a case where the fixed imaging/moving imaging is detected, a change in the fixed imaging and the moving imaging is predicted from the past history. In addition, in a case where the color of the traffic light in front of the vehicle is detected, the traveling situation of the vehicle may be estimated by predicting the change in the color of the traffic light, and a change in the fixed imaging and the moving imaging may be predicted. In a case where the operation information of the user of the vehicle is detected, the traveling situation of the vehicle may be estimated by predicting the next operation of the user, and a change in the fixed imaging and the moving imaging may be predicted.

The determination unit 240 determines the recognition model as the switching destination and the switching timing according to the predicted change in the imaging state of the video. The determination unit 240 refers to the imaging state-recognition model table in the storage unit 260, and determines the recognition model corresponding to the predicted imaging state. In the example of the imaging state-recognition model table of FIG. 25, in a case where it is predicted that the imaging state is changed from the fixed imaging to the moving imaging, it is determined to switch the recognition model from M11 to M12, and the timing at which the imaging state is changed from the fixed imaging to the moving imaging is determined as the switching timing. In addition, in a case where the color of the traffic light in front of the vehicle is detected, the recognition model as the switching destination and the switching timing may be determined using the timing at which the color of the traffic light is changed from red to blue as the timing at which the imaging status is changed from the fixed imaging to the moving imaging. In a case where the operation of the user of the vehicle is predicted, the recognition model as the switching destination and the switching timing may be determined using the timing of starting the operation of the accelerator pedal as the timing at which the imaging status is changed from the fixed imaging to the moving imaging.

As described above, in the remote monitoring system of the first example embodiment, a change in the imaging state of the video such as the start of the movement of the camera may be predicted, and the recognition model for analyzing the video may be switched according to the predicted change in the imaging state. As a result, the recognition model can be appropriately selected according to the change in the imaging state of the video, and the recognition accuracy in the recognition model as the switching destination can be improved as in the first example embodiment.

### Tenth Example Embodiment

Next, a tenth example embodiment will be described. In the present example embodiment, an example will be described in which two recognition models are arranged at different points, and the recognition model is switched according to a change in a calculation amount of a video, as the change in the video recognition environment.

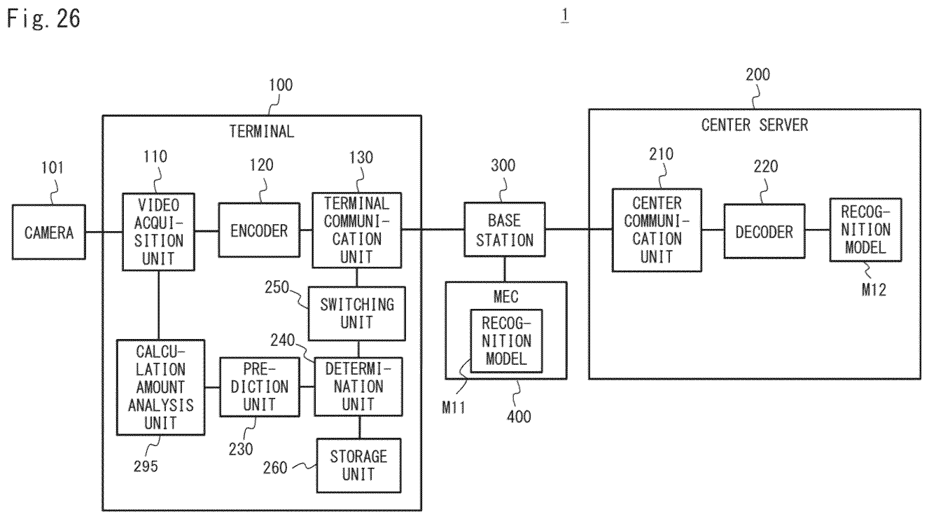

FIG. 26 illustrates a configuration example of the remote monitoring system 1 according to the present example embodiment. As illustrated in FIG. 26, in the present example embodiment, a basic configuration is similar to that of the first example embodiment, but an arrangement of each unit is different. That is, the MEC 400 includes the recognition model M11, and the center server 200 includes the recognition model M12. In addition, the terminal 100 includes the prediction unit 230, the determination unit 240, the switching unit 250, and the storage unit 260. Furthermore, the terminal 100 includes a calculation amount analysis unit 295. Note that the present example embodiment may be applied to other example embodiments. Here, a configuration different from that of the first example embodiment will be mainly described.

In the present example embodiment, the recognition models M11 and M12 are recognition models that have learned videos having different calculation capabilities and different calculation amounts required for the analysis and recognition of the video. The recognition model M11 learns a video that can be analyzed and recognized with a first calculation amount, and the recognition model M12 learns a video that can be analyzed and recognized with a second calculation amount. For example, the first calculation amount is lower than the second calculation amount, the recognition model M11 is a low calculation amount model, and the recognition model M12 is a high calculation amount model, but the present invention is not limited thereto.

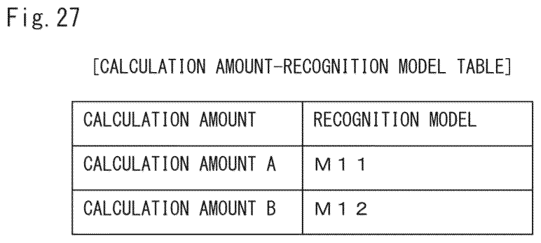

As an example of the video recognition environment-recognition model table, the storage unit 260 stores a calculation amount-recognition model table in which a calculation amount of a video than can be analyzed and recognized and a recognition model are associated with each other. FIG. 27 illustrates a specific example of the calculation amount-recognition model table. In this example, a calculation amount A and the recognition model M11 are associated with each other, and a calculation amount B and the recognition model M12 are associated with each other. The calculation amounts A and B may include a range of calculation amounts. The calculation amounts A and B correspond to the calculation amount of the video learned by each recognition model, for example, the calculation amount A is a low calculation amount lower than the calculation amount B, and the calculation amount B is a high calculation amount higher than the calculation amount A.

The calculation amount analysis unit 295 analyzes the calculation amount required for the analysis and recognition of the video. For example, the calculation amount analysis unit 295 may associate an object with a calculation amount, detect the object in the video, and determine the calculation amount from The object in the video may be detected, the movement of the detected object. the object between frames may be extracted, and the calculation amount may be determined from the extracted movement amount. In addition, the behavior recognized by the recognition models M11 and M12 may be associated with the calculation amount, the recognition result may be acquired from the recognition model M11 or M12, and the calculation amount may be determined from the recognized behavior.

The prediction unit 230 predicts a change in the calculation amount required for the analysis and recognition of the video. The prediction unit 230 periodically acquires the calculation amount analyzed by the calculation amount analysis unit 295, and predicts a change in the subsequent calculation amount on the basis of the history of the acquired past calculation amount.

The determination unit 240 determines the recognition model as the switching destination and the switching timing according to the predicted change in the calculation amount. The determination unit 240 refers to the calculation amount-recognition model table in the storage unit 260, and determines the recognition model corresponding to the predicted calculation amount. In the example of the calculation amount-recognition model table of FIG. 27, in a case where it is predicted that the calculation amount is changed from the calculation amount A to the calculation amount B, it is determined to switch the recognition model from M11 to M12, and the timing at which the calculation amount is changed from the calculation amount A to the calculation amount B is determined as the switching timing.

The switching unit 250 transmits the video to the recognition model determined by the determination unit 240. In a case where the recognition model M11 is selected, the video is transmitted to the MEC 400, and in a case where the recognition model M12 is selected, the video is transmitted to the center server 200. The switching unit 250 switches a transmission destination of the video according to the switching timing. From the pre-input timing to the switching timing, the video is transmitted to the recognition model before the switching and the recognition model after the switching, and after the switching timing, the video is transmitted to the recognition model after the switching.

As described above, in the remote monitoring system of the first example embodiment, recognition models having different calculation amounts may be arranged at different points. For example, by executing the low calculation amount model in the MEC and executing the high calculation amount model in the center, the calculation resources of the MEC and the center can be efficiently used, and the number of videos that can be analyzed and recognized in the entire system can be increased.

In addition, the recognition result of the recognition model of the MEC may be used on the terminal side or the site. Since the MEC is often closer to the site than the center side, the MEC can transmit the recognition result to the terminal or the device in the site earlier. As a result, in the present example embodiment, it is possible to quickly use the recognition result on the terminal side or the site by utilizing the recognition model of the MEC.

### Eleventh Example Embodiment

Next, an eleventh example embodiment will be described. In the present example embodiment, an example will be described in which two recognition models are arranged at different points, and the recognition model is switched according to a change in a band for transmitting a video, as the change in the video recognition environment.

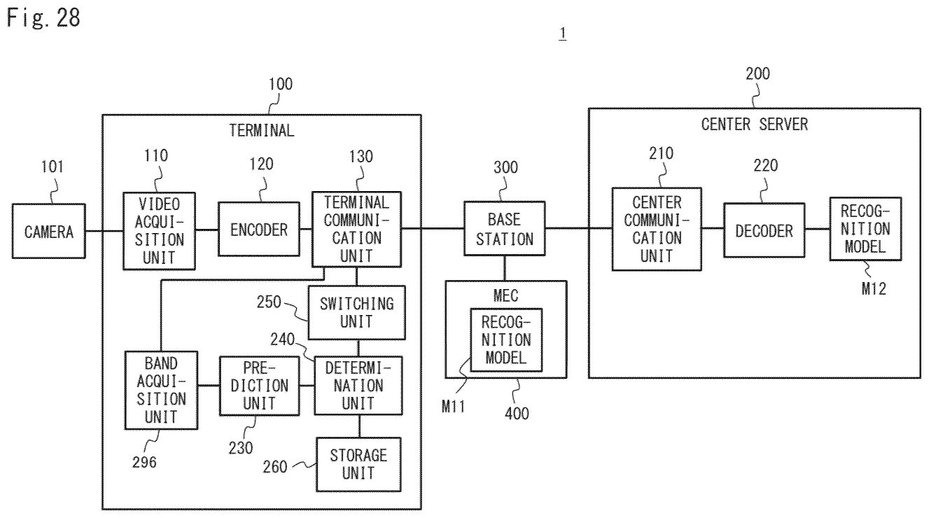

FIG. 28 illustrates a configuration example of the remote monitoring system 1 according to the present example embodiment. As illustrated in FIG. 28, in the present example embodiment, as compared with the tenth example embodiment, the terminal 100 includes a band acquisition unit 296 instead of the calculation amount analysis unit 295. Other configurations are similar to those of the tenth example embodiment. Here, a configuration different from that of the tenth example embodiment will be mainly described. In the present example embodiment, the recognition models M11 and M12 may be recognition models having different calculation amounts as in the tenth example embodiment, or may be the same recognition model.

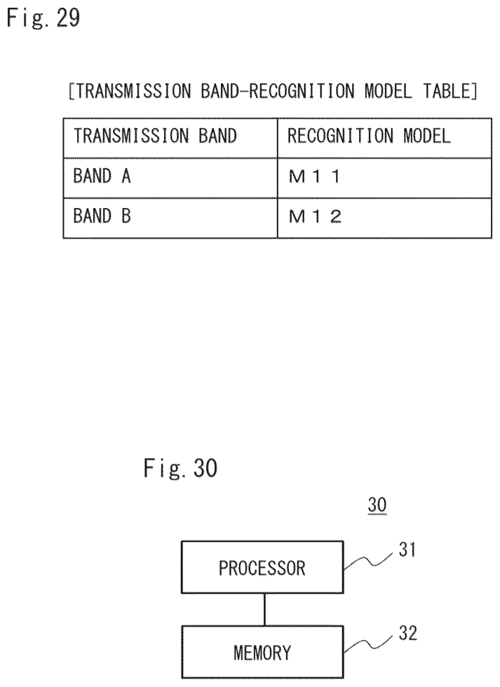

As an example of the video recognition environment-recognition model table, the storage unit 260 stores a transmission band-recognition model table in which a transmission band between the terminal and the center server, that is, a bandwidth and a recognition model are associated with each other. FIG. 29 illustrates a specific example of the transmission band-recognition model table. In this example, a transmission band A and the recognition model M11 are associated with each other, and a transmission band B and the recognition model M12 are associated with each other. The transmission band A and the transmission band B have different bandwidths. For example, the transmission band A is a narrow band narrower than the transmission band B, and the transmission band B is a wide band wider than the transmission band A.

The band acquisition unit 296 acquires a transmission band between the terminal 100 and the center server 200. The transmission band may be obtained on the basis of the communication speed estimated on the basis of the data amount transmitted from the terminal communication unit 130. The communication speed measured by the base station 300 or the terminal 100 may be acquired, and the transmission band may be determined from the acquired communication speed.

The prediction unit 230 predicts a change in the transmission band. The prediction unit 230 periodically acquires the transmission band acquired by the band acquisition unit 296, extracts the tendency of transition of the transmission band on the basis of the history of the acquired past transmission band, and predicts a subsequent change in the transmission band.

The determination unit 240 determines the recognition model as the switching destination and the switching timing according to the predicted change in the transmission band. The determination unit 240 refers to the transmission band-recognition model table in the storage unit 260, and determines the recognition model corresponding to the predicted transmission band. In the example of the transmission band-recognition model table of FIG. 29, in a case where it is predicted that the transmission band is changed from the transmission band A to the transmission band B, it is determined to switch the recognition model from M11 to M12, and the timing at which the transmission band is changed from the transmission band A to the transmission band B is determined as the switching timing.

As described above, in the remote monitoring system of the tenth example embodiment, the two recognition models may be arranged at different points, and the recognition model may be switched according to a change in the transmission band. Video recognition of the recognition model may be executed in the center in a case where a network band between the site and the center is sufficient, and video recognition of the recognition model may be executed in the MEC in a case where the network band is insufficient. This makes it possible to prevent a decrease in analysis accuracy caused by analyzing the low quality video in the center. In addition, a higher-quality video can be transmitted to the recognition model of the MEC or the center side, and the recognition accuracy can be improved as compared with a case where the recognition model exists in one place.

Note that the present disclosure is not limited to the above-described example embodiments, and can be appropriately modified without departing from the scope.

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 30. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage As an example and not by way of limitation, the computer-readable medium. medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system comprising:
a first video analysis model that analyzes a video corresponding to a first video recognition environment;
a second video analysis model that analyzes a video corresponding to a second video recognition environment; and
switching means for switching a video analysis model for analyzing video input data to be input, from the first video analysis model to the second video analysis model according to a change from the first video recognition environment to the second video recognition environment in the video input data,
wherein the switching means inputs video input data including data preceding a switching timing by a predetermined period to the second video analysis model according to the change from the first video recognition environment to the second video recognition environment in the video input data.

### Supplementary Note 2

The video processing system according to Supplementary Note 1, wherein the video input data including the data preceding the switching timing is video input data including data with a number of frames used by the second video analysis model to perform video recognition.

### Supplementary Note 3

The video processing system according to Supplementary Note 2, wherein the switching means inputs the video input data with the number of frames to both the first and second video analysis models.

### Supplementary Note 4

The video processing system according to any one of Supplementary Notes 1 to 3, further comprising: prediction means for predicting a change in a video recognition environment in the video input data,
wherein the switching means switches the video analysis model according to the predicted change in the video recognition environment.

### Supplementary Note 5

The video processing system according to any one of Supplementary Notes 1 to 4, wherein the video recognition environment includes a video parameter indicating a quality of a video.

### Supplementary Note 6

The video processing system according to Supplementary Note 5, wherein
the video parameter includes a frame rate, and
the video processing system further comprises specifying means for specifying a frame interval of the video input data according to the video analysis model to which the video input data is input.

### Supplementary Note 7

The video processing system according to any one of Supplementary Notes 1 to 6, further comprising: reception means for receiving the video input data via a network,
wherein the video recognition environment includes a communication quality of the video input data received by the reception means.

### Supplementary Note 8

The video processing system according to any one of Supplementary Notes 1 to 7, wherein the video recognition environment includes a scene in which the video is captured, a size of an object included in the video, a motion speed of the object included in the video, or an imaging state in which the video is captured.

### Supplementary Note 9

The video processing system according to any one of Supplementary Notes 1 to 8, wherein
the first video analysis model is arranged in one of an edge and a cloud, and
the second video analysis model is arranged in the other of the edge and the cloud.

### Supplementary Note 10

A video processing apparatus comprising:
a first video analysis model that analyzes a video corresponding to a first video recognition environment;
a second video analysis model that analyzes a video corresponding to a second video recognition environment; and
switching means for switching a video analysis model for analyzing video input data to be input, from the first video analysis model to the second video analysis model according to a change from the first video recognition environment to the second video recognition environment in the video input data,
wherein the switching means inputs video input data including data preceding a switching timing by a predetermined period to the second video analysis model according to the change from the first video recognition environment to the second video recognition environment in the video input data.

### Supplementary Note 11

The video processing apparatus according to Supplementary Note 10, wherein the video input data including the data preceding the switching timing by the predetermined period is video input data including data with a number of frames used by the second video analysis model to perform video recognition.

### Supplementary Note 12

The video processing apparatus according to Supplementary Note 11, wherein the switching means inputs the video input data with the number of frames to both the first and second video analysis models.

### Supplementary Note 13

The video processing apparatus according to any one of Supplementary Notes 10 to 12, further comprising: prediction means for predicting a change in a video recognition environment in the video input data,
wherein the switching means switches the video analysis model according to the predicted change in the video recognition environment.

### Supplementary Note 14

The video processing apparatus according to any one of Supplementary Notes 10 to 13, wherein the video recognition environment includes a video parameter indicating a quality of a video.

### Supplementary Note 15

The video processing apparatus according to Supplementary Note 14, wherein
the video parameter includes a frame rate, and
the video processing apparatus further comprises specifying means for specifying a frame interval of the video input data according to the video analysis model to which the video input data is input.

### Supplementary Note 16

A video processing method comprising:
switching a video analysis model for analyzing video input data to be input, from a first video analysis model that analyzes a video corresponding to a first video recognition environment, to a second video analysis model that analyzes a video corresponding to a second video recognition environment, according to a change from the first video recognition environment to the second video recognition environment in the video input data; and
inputting video input data including data preceding a switching timing by a predetermined period to the second video analysis model according to the change from the first video recognition environment to the second video recognition environment in the video input data.

### Supplementary Note 17

The video processing method according to Supplementary Note 16, wherein the video input data including the data preceding the switching timing by the predetermined period is video input data including data with a number of frames used by the second video analysis model to perform video recognition.

### Supplementary Note 18

The video processing method according to Supplementary Note 17, wherein the video input data with the number of frames is input to both the first and second video analysis models.

### Supplementary Note 19

The video processing method according to any one of Supplementary Notes 16 to 18, further comprising:
predicting a change in a video recognition environment in the video input data; and
switching the video analysis model according to the predicted change in the video recognition environment.

### Supplementary Note 20

The video processing method according to any one of Supplementary Notes 16 to 19, wherein the video recognition environment includes a video parameter indicating a quality of a video.

### Supplementary Note 21

The video processing method according to Supplementary Note 20, wherein
the video parameter includes a frame rate, and
the video processing method further comprises specifying a frame interval of the video input data according to the video analysis model to which the video input data is input.

### Supplementary Note 22

A video processing program for causing a computer to execute processing including:
switching a video analysis model for analyzing video input data to be input, from a first video analysis model that analyzes a video corresponding to a first video recognition environment, to a second video analysis model that analyzes a video corresponding to a second video recognition environment, according to a change from the first video recognition environment to the second video recognition environment in the video input data; and
inputting video input data including data preceding a switching timing by a predetermined period to the second video analysis model according to the change from the first video recognition environment to the second video recognition environment in the video input data.

### REFERENCE SIGNS LIST

1 REMOTE MONITORING SYSTEM
10 VIDEO PROCESSING SYSTEM
11 SWITCHING UNIT
20, 21, 22 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
110 VIDEO ACQUISITION UNIT
120 ENCODER
130 TERMINAL COMMUNICATION UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 CENTER COMMUNICATION UNIT
220 DECODER
230 PREDICTION UNIT
240 DETERMINATION UNIT
250 SWITCHING UNIT
260 STORAGE UNIT
270 BUFFER
280 FRAME SPECIFYING UNIT
290 COMMUNICATION QUALITY MEASUREMENT UNIT
291 SCENE ANALYSIS UNIT
292 OBJECT DETECTION UNIT
293 SPEED ANALYSIS UNIT
294 STATE ANALYSIS UNIT
295 CALCULATION AMOUNT ANALYSIS UNIT
296 BAND ACQUISITION UNIT
300 BASE STATION
400 MEC
401 COMPRESSION BIT RATE CONTROL FUNCTION
M1, M2, M11, M12 RECOGNITION MODEL

What is claimed is:

1. A video processing system comprising:
a first video analysis model that analyzes a video corresponding to a first video recognition environment;
a second video analysis model that analyzes a video corresponding to a second video recognition environment;
a memory configured to store instructions, and
a processor configured to execute the instructions to;
switch a video analysis model for analyzing video input data to be input, from the first video analysis model to the second video analysis model according to a change from the first video recognition environment to the second video recognition environment in the video input data, and
input video input data including data preceding a switching timing by a predetermined period to the second video analysis model according to the change from the first video recognition environment to the second video recognition environment in the video input data.

2. The video processing system according to claim 1, wherein the video input data including the data preceding the switching timing by the predetermined period is video input data including data with a number of frames used by the second video analysis model to perform video recognition.

3. The video processing system according to claim 2, wherein the processor is further configured to execute the instructions to input the video input data with the number of frames to both the first and second video analysis models.

4. The video processing system according to claim 1, wherein the processor is further configured to execute the instructions to predict a change in a video recognition environment in the video input data, and
switch the video analysis model according to the predicted change in the video recognition environment.

5. The video processing system according to claim 1, wherein the video recognition environment includes a video parameter indicating a quality of a video.

6. The video processing system according to claim 5, wherein
the video parameter includes a frame rate, and
the processor is further configured to execute the instructions to specify a frame interval of the video input data according to the video analysis model to which the video input data is input.

7. The video processing system according to claim 1, wherein the processor is further configured to execute the instructions to receive the video input data via a network, and
the video recognition environment includes a communication quality of the video input data received by the reception means.

8. The video processing system according to claim 1, wherein the video recognition environment includes a scene in which the video is captured, a size of an object included in the video, a motion speed of the object included in the video, or an imaging state in which the video is captured.

9. The video processing system according to claim 1, wherein
the first video analysis model is arranged in one of an edge and a cloud, and
the second video analysis model is arranged in the other of the edge and the cloud.

10. A video processing apparatus comprising:
a first video analysis model that analyzes a video corresponding to a first video recognition environment;
a second video analysis model that analyzes a video corresponding to a second video recognition environment;
a memory configured to store instructions, and
a processor configured to execute the instructions to;
switch a video analysis model for analyzing video input data to be input, from the first video analysis model to the second video analysis model according to a change from the first video recognition environment to the second video recognition environment in the video input data, and
input video input data including data preceding a switching timing by a predetermined period to the second video analysis model according to the change from the first video recognition environment to the second video recognition environment in the video input data.

11. The video processing apparatus according to claim 10, wherein the video input data including the data preceding the switching timing by the predetermined period is video input data including data with a number of frames used by the second video analysis model to perform video recognition.

12. The video processing apparatus according to claim 11, wherein the processor is further configured to execute the instructions to input the video input data with the number of frames to both the first and second video analysis models.

13. The video processing apparatus according to claim 10, wherein the processor is further configured to execute the instructions to predict a change in a video recognition environment in the video input data, and
switch the video analysis model according to the predicted change in the video recognition environment.

14. The video processing apparatus according to claim 10, wherein the video recognition environment includes a video parameter indicating a quality of a video.

15. The video processing apparatus according to claim 14, wherein
the video parameter includes a frame rate, and
the processor is further configured to execute the instructions to specify a frame interval of the video input data according to the video analysis model to which the video input data is input.

16. A video processing method comprising:
switching a video analysis model for analyzing video input data to be input, from a first video analysis model that analyzes a video corresponding to a first video recognition environment, to a second video analysis model that analyzes a video corresponding to a second video recognition environment, according to a change from the first video recognition environment to the second video recognition environment in the video input data; and
inputting video input data including data preceding a switching timing by a predetermined period to the second video analysis model according to the change from the first video recognition environment to the second video recognition environment in the video input data.

17. The video processing method according to claim 16, wherein the video input data including the data preceding the switching timing by the predetermined period is video input data including data with a number of frames used by the second video analysis model to perform video recognition.

18. The video processing method according to claim 16, wherein the video input data with the number of frames is input to both the first and second video analysis models.

19. The video processing method according to claim 16, further comprising:
predicting a change in a video recognition environment in the video input data; and
switching the video analysis model according to the predicted change in the video recognition environment.

20. The video processing method according to claim 16, wherein the video recognition environment includes a video parameter indicating a quality of a video.

21. (canceled)
